(19) United States
(12) Patent Application Publication
(10) Pub. No.: US 2025/0381892 A1
(43) Pub. Date: Dec. 18, 2025

(54) ANTI-SLIP MECHANISM, SAFETY BELT PROTECTION DEVICE, AND CHILD SAFETY SEAT

(71) Applicant: WONDERLAND SWITZERLAND AG, Steinhausen (CN)

(72) Inventors: Zhengwen GUO, Dongguan, Guangdong (CN); Xiaolong MO, Dongguan, Guangdong (CN); Kun ZHANG, Dongguan, Guangdong (CN); Xiaoqing CHEN, Dongguan, Guangdong (CN)

(73) Assignee: WONDERLAND SWITZERLAND AG, Steinhausen (CN)

(21) Appl. No.: 18/874,985

(22) PCT Filed: Jun. 14, 2023
(86) PCT No.: PCT/EP2023/065926

§ 371 Date: Dec. 13, 2024

(30) Foreign Application Priority Data
Jun. 14, 2022 (CN) 202210674741.2
Nov. 25, 2022 (CN) 202211493781.3

(51) Int. Cl. B60N 2/28; B60N 2/58

(52) U.S. Cl. CPC B60N 2/2812; B60N 2/2816; B60N 2/5833

(57) ABSTRACT

The present disclosure provides an anti-slip mechanism for a child safety seat. The anti-slip mechanism is disposed on at least one of a seat cloth and a seat body of the child safety seat to prevent the seat cloth of the child safety seat from sliding with respect to an object that contacts with the seat cloth. The present disclosure also provides a safety belt protection mechanism and a child safety seat.

### CROSS-REFERENCE TO RELATED APPLICATIONS

This application is a National Stage application of PCT/EP2023/065926, filed on Jun. 14, 2023, which claims the benefit of Chinese Applications No. 202210674741.2, filed on Jun. 14, 2022 and No. 202211493781.3, filed on Nov. 25, 2022, each of which are incorporated herein by reference in their entirety.

### TECHNICAL FIELD

The present disclosure relates to the field of children's products, and in particular to an anti-slip mechanism, a safety belt protection device, and a child safety seat having the anti-slip mechanism and/or the safety belt protection device.

### BACKGROUND

The existing child safety seats used in vehicles usually has two usage modes: “Harness usage mode” and “Booster usage mode”. When a child safety seat is installed in a vehicle and in the Booster usage mode, it is necessary to fix a child sitting in the child safety seat by means of a vehicle safety belt on the vehicle. For example, the safety belt is used to restrain the child on the child safety seat from the front of the child, and at this time, a waist belt portion of the safety belt is restrained around the abdomen of the child.

Thus, in order to improve the safety and comfort of the safety seat, it is demanded to provide an improved child safety seat, which at least has the following advantages, i.e., the child safety seat can prevent children from sliding with respect to the seat body, or prevent the shoulder belt portion of the safety belt from being pressed directly on the neck of the child.

### SUMMARY

An aspect of the present disclosure provides an anti-slip mechanism for a child safety seat. The anti-slip mechanism is disposed on at least one of a seat cloth and a seat body of a child safety seat to prevent the seat cloth of the child safety seat from sliding with respect to an object that contacts with the seat cloth.

Another aspect of the present disclosure provides a safety belt protection device installed to a seat body of a child safety seat, wherein the safety belt protection device is configured to engage at least a part of a safety belt and limit movement of the safety belt with respect to the child safety seat.

Another aspect of the present disclosure provides a child safety seat including the anti-slip mechanism and/or the safety belt protection device

Another aspect of the present disclosure provides a child safety seat including a seat body and the safety belt protection device; wherein a first side of the seat body is provided with a first opening, a second side of the seat body is provided with a second opening, a first end of the woven tape protrudes from the first side through the first opening and be connected to the first engaging element, a second end of the woven tape protrudes from the second side through the second opening and be connected to the second engaging element.

Another aspect of the present disclosure provides a child safety seat including a seat body for carrying a child; a headrest portion connected vertically above the seat body; and the safety belt protection device, the safety belt protection device being connected to the seat body or the headrest portion.

### BRIEF DESCRIPTION OF THE DRAWINGS

The accompanying drawings, which are included to provide a further understanding of the present disclosure and are incorporated in and constitute a part of this specification, illustrate embodiments of the present disclosure and together with the description below serve to explain the concept of the present disclosure.

FIG. 1 schematically shows a child safety seat according to an embodiment of the present disclosure;

FIG. 2 is an anti-slip mechanism disposed on the child safety seat shown in FIG. 1;

FIG. 3 schematically shows the child safety seat according to an embodiment of the present disclosure;

FIG. 4 schematically shows a plan view of a first anti-slip portion according to an embodiment of the present disclosure;

FIG. 5 schematically shows the child safety seat according to an embodiment of the present disclosure;

FIG. 6 is a plan view of the anti-slip mechanism shown in FIG. 5;

FIG. 7 schematically shows the child safety seat according to an embodiment of the present disclosure;

FIG. 8 schematically shows the child safety seat according to an embodiment of the present disclosure;

FIG. 9 schematically illustrates the child safety seat according to an embodiment of the present disclosure;

FIG. 10 schematically shows a perspective view of the child safety seat according to an embodiment of the present disclosure, which is applied with a safety belt protection device provided according to an embodiment of the present disclosure;

FIG. 11 schematically shows a cross-sectional view taken along a line E-E in FIG. 10;

FIG. 12 schematically shows a perspective view of the safety belt protection device according to an embodiment of the present disclosure;

FIG. 13 schematically shows a perspective view of the safety belt protection device according to another embodiment of the present disclosure;

FIG. 14 schematically shows a position of a limiting block of the safety belt protection device shown in FIG. 12 on the child safety seat;

FIG. 15 schematically shows another position of the limiting block of the safety belt protection device shown in FIG. 12 on the child safety seat;

FIG. 16 schematically shows yet another position of the limiting block of the safety belt protection device shown in FIG. 12 on the child safety seat;

FIG. 17 schematically shows a perspective view of a first sheath and a hook of the safety belt protection device according to an embodiment of the present disclosure when the first sheath and the hook are engaged with the shoulder belt portion, in which the first sheath is in a closed state;

FIG. 18 schematically shows a perspective view of the first sheath and the hook in FIG. 17, in which the first sheath is in an opened state;

FIG. 19 schematically shows a partial perspective view of the hook and a woven tape of the safety belt protection device according to an embodiment of the present disclosure;

FIG. 20 schematically shows a front perspective view of a second sheath of the safety belt protection device according to an embodiment of the present disclosure when the second sheath is engaged with the shoulder belt portion, in which the second sheath is in a closed state;

FIG. 21 schematically shows a perspective view of the second sheath in FIG. 19, in which the second sheath is in an opened state;

FIG. 22 schematically shows a rear perspective view of the second sheath of FIG. 19;

FIG. 23 schematically shows a perspective view of the child safety seat according to another embodiment of the present disclosure, which is applied with the safety belt protection device according to an embodiment of the present disclosure, the safety belt protection device being used to pull the vehicle safety belt on the left side;

FIG. 24 schematically shows a perspective view of the child safety seat according to another embodiment of the present disclosure, which is applied with the safety belt protection device according to an embodiment of the present disclosure, the safety belt protection device being used to pull the vehicle safety belt on the right side;

FIG. 25 schematically shows a rear perspective view of a third sheath and a first woven tape of the safety belt protection device shown in FIGS. 23 and 24;

FIG. 26 schematically shows a perspective view of the third sheath in FIG. 23 and FIG. 24, in which the third sheath is in an opened state;

FIG. 27 schematically shows a perspective view of the child safety seat according to yet another embodiment of the present disclosure, which is applied with the safety belt protection device according to an embodiment of the present disclosure;

FIG. 28 is a front view of the child safety seat according to an embodiment of the present disclosure;

FIG. 29 is an enlarged view at a block part shown in FIG. 28;

FIG. 30 is a perspective view of the safety belt protection device;

FIG. 31 is a front view of the child safety seat when in use;

FIG. 32 is a rear view of the child safety seat;

FIG. 33 is an enlarged view at a block part shown in FIG. 32;

FIG. 34 is a perspective view of the child safety seat, in which the seat body is removed to clearly show a headrest portion and the safety belt protection device;

FIG. 35 is a rear view of the child safety seat, in which the seat body is removed to clearly show the headrest portion and the safety belt protection device;

FIG. 36 is an enlarged view at a block shown in FIG. 35;

FIG. 37 is a perspective view of the child safety seat according to another embodiment of the present disclosure;

FIG. 38 is a rear view of the child safety seat according to another embodiment of the present disclosure; and

FIG. 39 is an enlarged view at a block shown in FIG. 38.

### List of Reference Numbers

1100, 1200, 1200a, 1200b, 1300, 1400 Child Safety Seat
1130, 1230, 1230a, 1230b, 1430 First Anti-slip Portion
1231a Ventilation Hole
1340, 1440 Second Anti-slip Portion
1341, 1441 Connecting Element
1342, 1442 Fitting Element
1110, 1210, 1210a, 1210b, 1310, 1410 Seat Cloth
1111, 1211, 1211b, 1311, 1411 Buttock Area
1112 Leg Area
1113 Side Leg Area
1114 Lower Leg Area
1220, 1320, 1420 Seat Body
2100 Child Safety Seat
2001 Safety Belt Protection Device
2011 First Engaging Element
2012 Second Engaging Element
2013 Woven Tape
2130 Connecting Ring
2131 First End
2132 Second End
2136 Indication Area
2004 First Limiting Structure
2041 Limiting Block
2042 Limiting Ring
2005 Second Limiting Structure
2510 First Blocking Surface
2511 First Perforation
2520 Second Blocking Surface
2521 Second Perforation
2053 Limiting Column
2003 Hook
2031 Connecting Portion
2036 Prompt Area
2006 Auxiliary Belt
2061 First End
2062 Second End
2007 First Sheath
2071 First Half Part
2711 Side Portion
2072 Second Half Part
2721 Side Portion
2073 Positioning Structure
2073a Strip
2731 First End
2732 Second End
2009 Second Sheath
2091 Third Half Part
2911 Side Portion
2092 Fourth Half Part
2921 Side Portion
2093 Connecting Sleeve
2010 Third Sheath
2103 Fifth Half Part
2103a Side Portion
2104 Sixth Half Part
2104a Side Portion
2002 Seat Body
2021 First Side
2210 First Opening
2022 Second Side
2220 Second Opening
2020 Connecting Structure
2051, 2052 Longitudinal Beam
2002a Seat Portion
2002b Backrest Portion
2008 Safety belt
2081 Shoulder Belt Portion
2082 Waist belt portion
2083 Belt Buckle
2010a First Woven Tape
2101 First End
2102 Second End
2105 Snap Button Structure
2010b Second Woven Tape
L, R Arrow
3001 Child Safety Seat
3100 Safety Belt Protection Device
3110 Guiding Portion
3111 Bottom Portion
3112 Side Portion
3113 Channel
3120 Connecting Portion
3121 Extension
3122 Ball Portion
3123 Connecting Belt
3124 Engagement Element
3124a First Transverse Portion
3124b Vertical Portion
3124c Second Transverse Portion
3200 Seat Body
3210 Seat Portion
3220 Backrest Portion
3220a Backrest Surface
3220b Wing Portion
3230 Headrest Portion
3240 Sliding Slot
3241 Protrusion
3300 Safety Belt
3310 First End
3320 Second End
3330 Middle Portion
3400 Passenger
3410 Head
3420 Shoulder

### DETAILED DESCRIPTION

Although the present disclosure is illustrated and described herein with reference to particular embodiments, the present disclosure should not be limited to the details as shown. Rather, various modifications may be made in these details, within the scope of equivalents of the claims and without departing from the present disclosure.

The descriptions of directions such as “front”, “rear”, “upper” and “lower” mentioned herein are only for the convenience of understanding, and the present disclosure is not limited to these directions, which can be adjusted according to actual conditions.

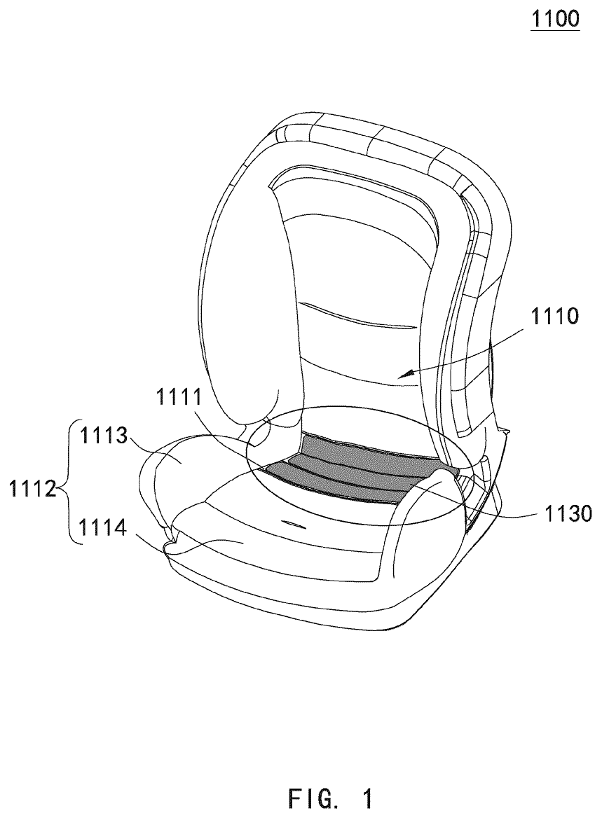

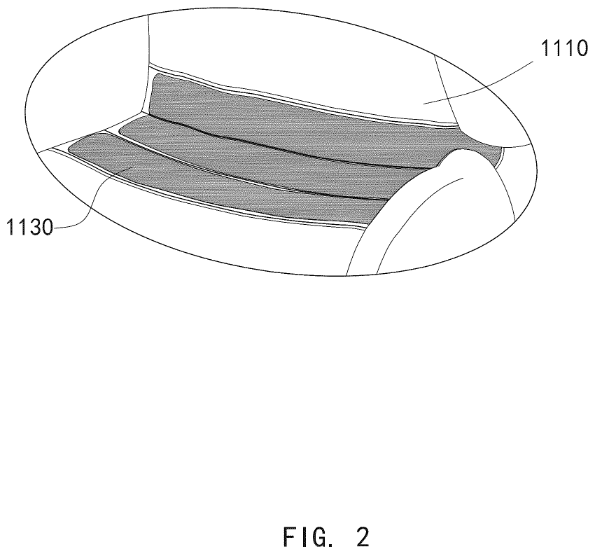

Referring to FIGS. 1 and 2, FIGS. 1 and 2 schematically shows a child safety seat 1100 and an anti-slip mechanism provided thereon according to an embodiment of the present disclosure. FIG. 1 shows the child safety seat 1100 provided with the anti-slip mechanism, and FIG. 2 shows a partially enlarged view of the anti-slip mechanism. An object of this embodiment is to provide a child safety seat that can reduce forward displacement of a child when the child safety seat is impacted. Another object of this embodiment is to provide an anti-slip mechanism having simple structure, convenient production and processing, and low cost.

The child safety seat 1100 includes a seat body and a seat cloth 1110 sleeved over the seat body. The seat body of the child safety seat 1100 in FIG. 1 is covered by the seat cloth 1110, and thus is not shown. As shown in FIG. 1, the seat cloth 1110 of the child safety seat 1100 includes a buttock area 1111 and a leg area 1112. The buttock area 1111 is generally located on the seat cloth of the child safety seat 1100 close to the backrest. The leg area 1112 is generally located in other areas of the seat cloth of the child safety seat 1100 and includes a side leg area 1113 and a lower leg area 1114.

The child safety seat 1100 according to the present disclosure is provided with an anti-slip mechanism. In one embodiment, the anti-slip mechanism is provided on the seat cloth 1110 of the child safety seat 1100 to prevent the seat cloth 1110 from sliding with respect to an object that contacts with the seat cloth (such as a child sitting on the seat cloth 1110 of the child safety seat 1100, or the seat body of the child safety seat 1100 that is in contact with an inner surface of the seat cloth 1110, or the like).

As shown in FIG. 1, the anti-slip mechanism includes a first anti-slip portion 1130. The first anti-slip portion 1130 is disposed on an outer surface of the seat cloth 1110, and is at least partially disposed at the buttock area 1111, so as to increase a friction between the child sitting on the seat cloth 1110 in the child safety seat 1100 and the seat cloth 1110 of the seat 1100. However, the present disclosure is not limited thereto. In other embodiments, the first anti-slip portion 1130 may also be provided at the leg area 1112, such as the side leg area 1113 and/or the lower leg area 1114, so as to increase a friction between the child and the seat cloth 1110 of the seat 1100 from multiple orientations.

As shown in FIG. 2, the first anti-slip portion 1130 is sewn, glued or printed on the seat cloth 1110, or be disposed on the seat cloth 1110 in other fixing manners. The first anti-slip portion 1130 is made of a material with greater friction than the seat cloth 1110, and optionally, the first anti-slip portion 1130 is a material with greater friction such as a silicone sheet or a rubber sheet.

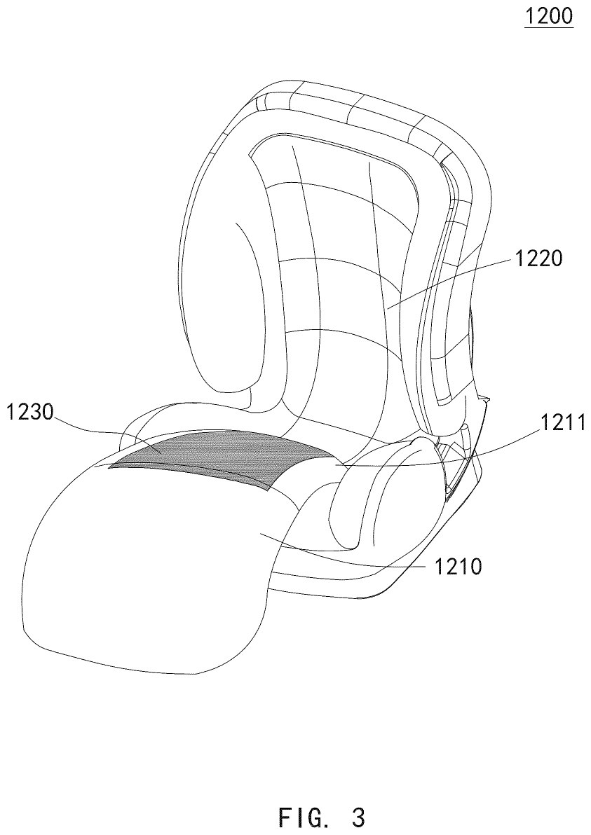

Referring to FIG. 3, FIG. 3 schematically shows a child safety seat 1200 according to another embodiment of the present disclosure. In FIG. 3, a seat cloth 1210 located at a backrest portion of the child safety seat 1200 is folded forward to show an anti-slip mechanism on an inner surface of the seat cloth 1210.

The anti-slip mechanism of the child safety seat 1200 according to this embodiment is disposed on the inner surface of the seat cloth 1210 (that is, a surface opposite to a seat body 1220 of the child safety seat 1200), thereby increasing a friction between the seat cloth 1210 and the seat body 1220 of the child safety seat 1200 to greatly reduce a possible displacement therebetween.

As shown in FIG. 3, in this embodiment, the anti-slip mechanism includes a first anti-slip portion 1230, and the first anti-slip portion 1230 is disposed on the inner surface of the seat cloth 1210, and is at least partially disposed at the buttock area 1211 of the seat cloth 1210 of the child safety seat 1100. However, the present disclosure is not limited thereto. In other embodiments of the present disclosure, the first anti-slip portion 1230 may also be provided on the seat body 1220 of the child safety seat 1200, for example, at a position of the seat body 1220 corresponding to the buttock area 1211 of the seat cloth 1210. In one embodiment, the first anti-slip portion 1230 is a single component disposed on the seat cloth 1210, as shown in the shaded part in FIG. 3.

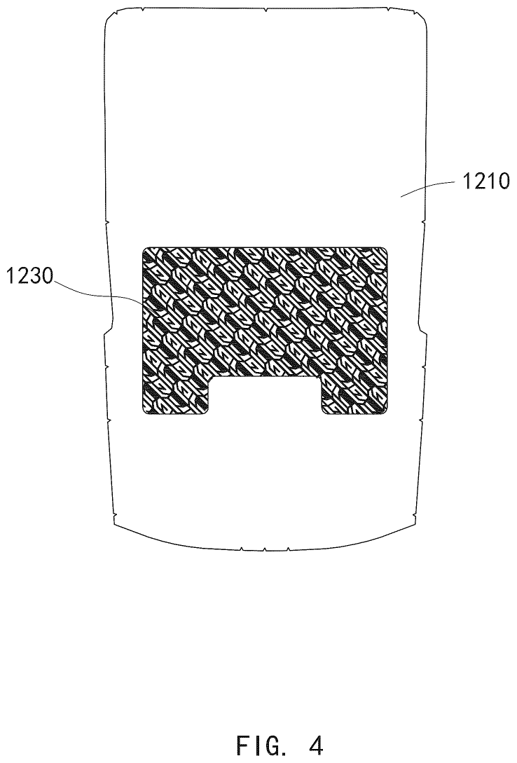

Referring to FIG. 4, FIG. 4 schematically shows a plan view of the first anti-slip portion 1230 according to an embodiment of the present disclosure. As shown in FIG. 4, embossed patterns are provided on the surface of the first anti-slip portion 1230, and are substantially evenly distributed with a certain regularity. In one embodiment, the first anti-slip portion 1230 is made of silicone material and printed on the inner surface of the seat cloth 1210.

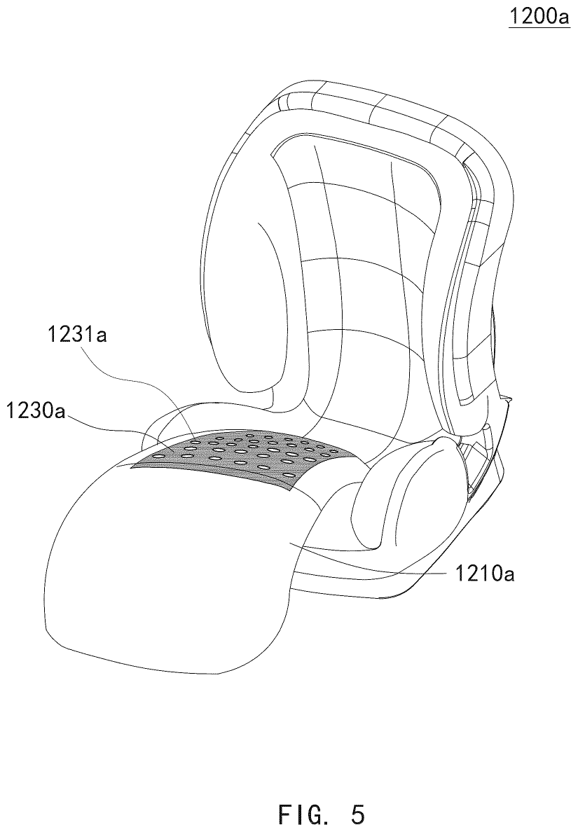

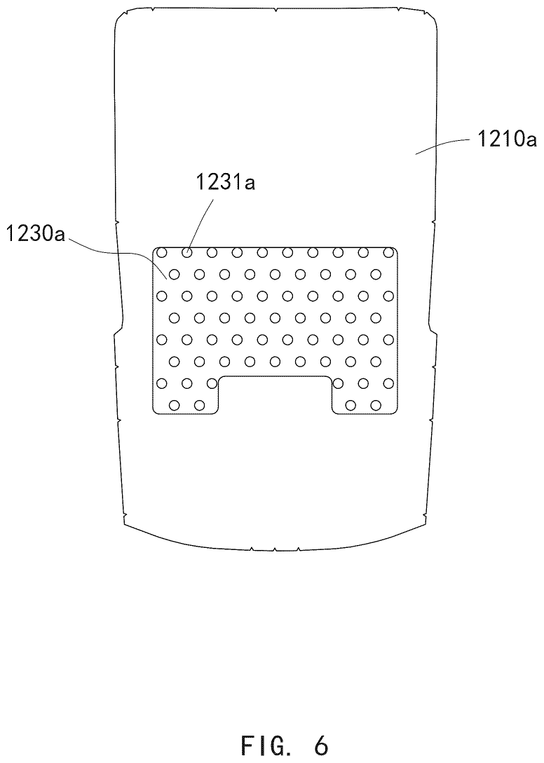

Referring to FIGS. 5 and 6, FIGS. 5 and 6 show plan views of the child safety seat 1200a and the first anti-slip portion 1230a provided thereon according to an embodiment of the present disclosure.

In one embodiment, ventilation holes 1231a are disposed on the first anti-slip portion 1230a. Specifically, the ventilation holes 1231a are formed on the first anti-slip portion 1230a by punching. For example, when the first anti-slip portion 1230a is made of silicone material, the ventilation hole 1231a is punched on a silicone layer to remove a part of the silicone layer after the silicone layer is printed, so that no silicone layer is disposed at a position where the ventilation holes 1231a are provided. Optionally, the first anti-slip portion 1230a having the ventilation holes 1231a is directly formed on the seat cloth 1210a by forming the ventilation holes 1231a in some areas during the printing and forming process.

It should be noted that, in this embodiment, the ventilation holes 1231a are only provided in a silicone printing area, so as to improve the permeability of the seat cloth 1210a after printing the silicone. A size of the silicone printing area is between 230 mm*150 mm and 250 mm*170 mm, preferably 243 mm*165 mm. The ventilation holes 1231a are evenly distributed in the silicone printing area, for example, are arranged in a manner as shown in FIG. 6, and an interval in a vertical direction or a horizontal direction is in a range of 10 mm to 20 mm, preferably 15 mm. In addition, a diameter of the ventilation hole 1231a is in a range of 5 mm to 15 mm, preferably 10 mm.

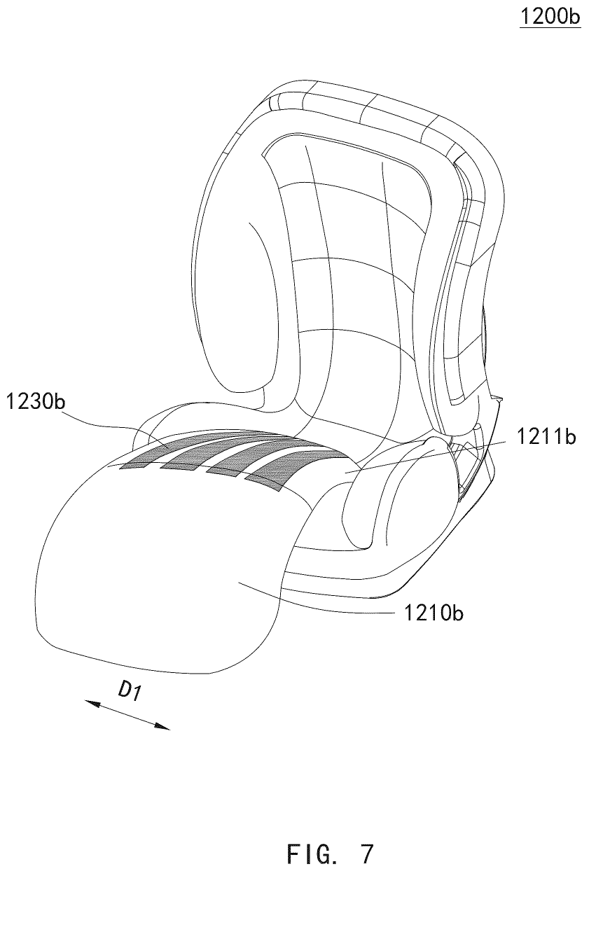

Referring to FIG. 7, FIG. 7 schematically shows a child safety seat 1200b according to an embodiment of the present disclosure.

In one embodiment, as shown in FIG. 7, the first anti-slip portion 1230b is a plurality of components evenly distributed on the seat cloth 1210b of the child safety seat 1200b, such as a plurality of strip-shaped members shown in FIG. 7 that are evenly distributed in a transverse direction D1. The first anti-slip portion 1230b, which is composed of a plurality of uniformly distributed components, is disposed on the inner surface of the seat cloth 1210b by sewing, pasting, printing or other fixing manners, and is at least partially located in the buttock area 1211b of the child safety seat 1200b. The components of the first anti-slip portion 1230b are all made of materials with greater friction than the seat cloth 1210b, and optionally, they are made of materials with greater friction such as a silicone sheet or a rubber sheet.

In addition, the structure of the first anti-slip portion of the present disclosure is not limited thereto. In other embodiments, the first anti-slip portion is a circular, elliptical or other integral structure, or a circular array, rectangular array or other discrete structure uniformly distributed in the transverse direction and the longitudinal direction.

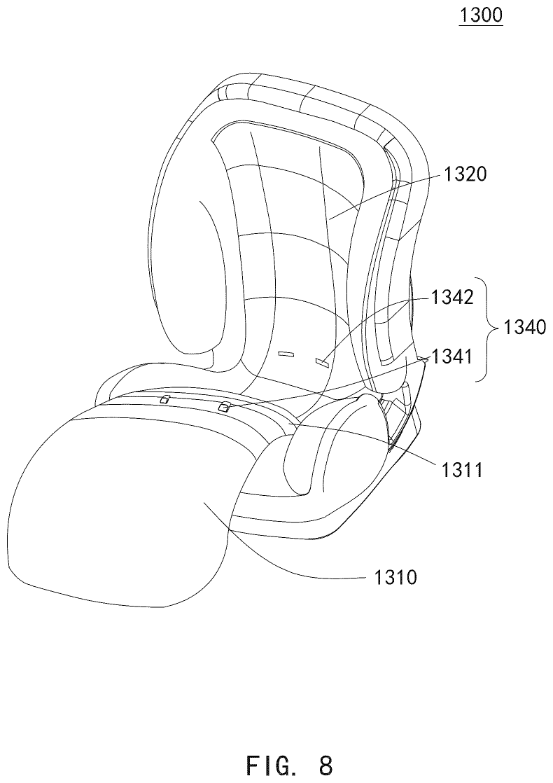

Referring to FIG. 8, FIG. 8 schematically shows a child safety seat 1300 and a anti-slip mechanism provided thereon according to an embodiment of the present disclosure.

The anti-slip mechanism in this embodiment includes a second anti-slip portion 1340 for positioning the seat cloth 1310 on the seat body 1320 of the child safety seat 1300 covered by the seat cloth 1310. In one embodiment, the second anti-slip portion 1340 is provided at least at the buttock area 1311 of the seat cloth 1310 of the child safety seat 1300. As shown in FIG. 8, the second anti-slip portion 1340 includes one or more connecting elements 1341 disposed on the seat cloth 1310 and one or more fitting elements 1342 disposed at corresponding positions on the seat body 1320 of the child safety seat 1300. Specifically, the one or more connecting elements 1341 are provided on the buttocks area 1311 of the seat cloth 1310, and the one or more fitting elements 1342 are disposed at an area of the seat body 1320 corresponding to the buttocks area 1311. The connecting element 1341 is detachably connected to the fitting element 1342, so that after the seat cloth 1310 is sleeved on the seat body 1320 of the child safety seat 1300, the seat cloth 1310 and the seat body 1320 are fixed again, so as to increase a fastening force between the seat cloth 1310 and the seat body 1320, and prevent the seat cloth 1310 from sliding forward with respect to the seat body 1320 and driving the child sitting thereon to slide forward. In one embodiment, one of the connecting element 1341 and the fitting element 1342 is a clamping opening or a clamping slot or a cloth loop; and the other of the connecting element 1341 and the fitting element 1342 is a hook or a fixing buckle.

Optionally, the one or more connecting elements 1341 are provided at an edge of the seat cloth 1310, or at an edge of the buttock area 1311 of the seat cloth 1310, and the one or more fitting elements 1342 are provided at the corresponding position of the seat body 1320 of the child safety seat 1300, so as to more firmly position the seat cloth 1310 to the seat body 1320. Optionally, the connecting element 1341 is disposed at a corner of the entire structure of the seat cloth 1310. In addition, the connecting elements 1341 and the fitting elements 1342 are disposed centrally or symmetrically with respect to a longitudinal central axis of the child safety seat 1100. In other embodiments, the connecting element 1341 and the fitting element 1342 are disposed at the leg area of the seat cloth, or the like.

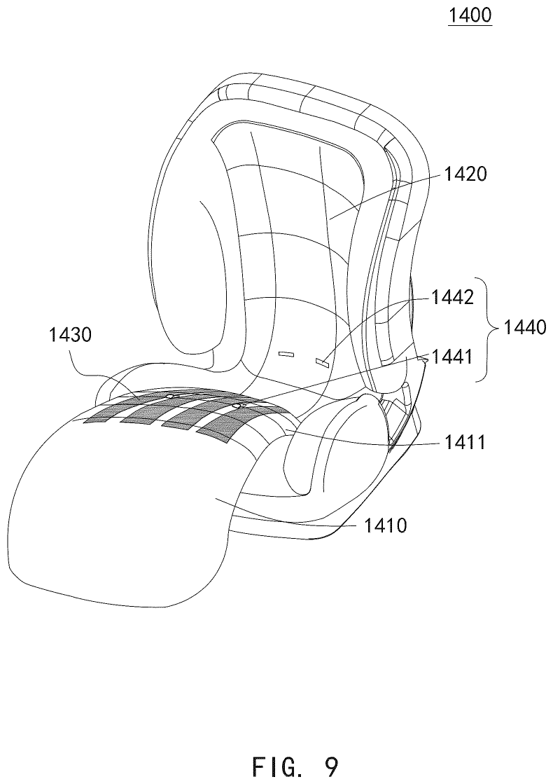

Referring to FIG. 9, FIG. 9 schematically shows a child safety seat 1400 and the anti-slip mechanism provided thereon according to an embodiment of the present disclosure.

As shown in FIG. 9, the anti-slip mechanism of the child safety seat 1400 of this embodiment includes a first anti-slip portion 1430 and a second anti-slip portion 1440. The first anti-slip portion 1430 is provided on the inner surface of the seat cloth 1410, and may be replaced by the structure in any embodiment as shown in FIGS. 3 to 7, which will not be repeated herein. The second anti-slip portion 1440 is configured to position the seat cloth 1410 on the seat body 1420 of the child safety seat 1400, and includes one or more connecting elements 1441 disposed on the seat cloth 1410 and one or more fitting elements 1442 disposed at corresponding positions on the seat body 1420 of the child safety seat 1400, wherein these connecting elements 1441 and fitting elements 1442 have the same structure as the embodiment shown in FIG. 8, which will not be repeated herein. Optionally, both the first anti-slip portion 1430 and the second anti-slip portion 1440 are disposed at least at the buttock area 1411 of the seat cloth 1410.

By cooperating the first anti-slip portion 1430 with the second anti-slip portion 1440, friction and connection may be simultaneously formed between the seat cloth 1410 and the seat body 1420, and the friction and fastening force between the two can be increased at the same time, further reducing the possible forward displacement of the seat cloth 1410 with respect to the seat body 1420 when the vehicle (for example, a car as described in the present embodiment) is impacted, thereby reducing the forward displacement of the child sitting on the child safety seat 1400, and reducing the pressure of the safety belt on the abdomen of the child.

In addition, it should be noted that the above-mentioned embodiments of the present disclosure may also be used in combination. For example, the first anti-slip portion located on the outer surface of the seat cloth in the embodiment shown in FIG. 1, and the first anti-slip portion and/or the second anti-slip portion located on the inner surface of the seat cloth in any embodiment shown in FIGS. 3 to 9 may be provided simultaneously. By providing the first anti-slip portion on the outer surface of the seat cloth and the first anti-slip portion/second anti-slip portion on the inner surface of the seat cloth simultaneously, the friction and fastening force between the child and the seat cloth and between the seat cloth and the seat body are increased, thereby greatly reducing the forward displacement of the seat cloth and the child, and greatly reducing the pressure of the safety belt on the abdomen of the child.

As mentioned above, by providing the anti-slip mechanism according to the present disclosure, the safety of the child safety seat can be effectively improved, and the influence caused by the impact on the vehicle on the child sitting on the child safety seat can be greatly reduced.

For example, data results for impact tests performed without the anti-slip mechanism and impact tests performed with the anti-slip mechanism of the embodiment of the present disclosure are listed in TABLE 1 and TABLE 2 as shown below, respectively. In the TABLE 1 and TABLE 2, Q3, Q6, and Q10 respectively represent dummies with different weights and heights, for example, the height and weight of Q3 are smaller than those of Q10.

TABLE 1
(without anti-slip mechanism):

| | | | Abdominal Pressure |
|---|---|---|---|
| | | Resultant Acceleration | Unit: bar |
| Dummy | | at the Head Unit: G | Q10 ≤1.2 |
| Number | Seat Angle | Q3/Q6 ≤80 | Q3, Q6 ≤1.0 |
| Q3 | Upright | 104.2 | 0.7 |
| Q3 | Upright | 85.02 | 0.6 |
| Q6 | Recline | 88.07 | 1.04 |
| Q6 | Upright | 82.33 | 1.3 |
| Q10 | Upright | 52.96 | 1.19 |
| Q10 | Recline | 65.51 | 1.47 |
| Q10 | Upright | 63.64 | 1.32 |
| Q10 | Upright | 78.94 | 0.82 |
| Q10 | Recline | 91.21 | 0.65 |
| Q10 | Upright | 71.16 | 0.76 |
| Q10 | Recline | 93.95 | 0.72 |

As mentioned in TABLE 1, in the test about the resultant acceleration at the head (which may be also called as head resultant acceleration) when the vehicle is impacted, when the anti-slip mechanism is not used in the child safety seat, the head resultant acceleration experienced by Q3 or Q6 exceeds a safe range (that is, greater than 80), and the head resultant acceleration experienced by the Q10 has a high probability of exceeding the safe range. In addition, in the test about the abdominal pressure exerted by the safety belt on the dummy when the vehicle is impacted, pressures beyond the safe range (such as 1.0 or 1.2) are applied on various dummies to varying degrees.

TABLE 2
(using the anti-slip mechanism of the
embodiment of the present disclosure):

| | | | Abdominal Pressure |
|---|---|---|---|
| | | Resultant Acceleration | Unit: bar |
| Dummy | | at the Head Unit: G | Q10 ≤1.2 |
| Number | Seat Angle | Q3/Q6≤80 | Q3, Q6 ≤1.0 |
| Q3 | Upright | 74.84 | 0.34 |
| Q3 | Recline | 72.22 | 0.35 |
| Q3 | Upright | 76.67 | 0.3 |
| Q3 | Recline | 72.39 | 0.28 |
| Q6 | Upright | 67.52 | 0.58 |
| Q6 | Recline | 79.17 | 0.77 |
| Q6 | Upright | 76.18 | 0.83 |
| Q6 | Recline | 69.79 | 0.84 |
| Q10 | Upright | 70.23 | 0.46 |
| Q10 | Recline | 75.56 | 0.49 |
| Q10 | Upright | 73.68 | 0.56 |
| Q10 | Recline | 73.13 | 0.51 |

As shown in TABLE 2, the anti-slip mechanism of the embodiment of the present disclosure is provided to ensure that the resultant acceleration of the head and abdominal pressure when the vehicle is impacted are both within the safe range.

Thus, by comparing the sets of test data shown in TABLE 1 and TABLE 2, it can be seen that, providing the anti-slip mechanism according to the embodiment of the present disclosure not only can effectively and greatly reduce the pressure exerted by the safety belt on the abdomen of the child (i.e., abdominal pressure) when the vehicle is impacted, but also can significantly reduce the head resultant acceleration experienced by the child, thereby further improving travel safety.

Therefore, the anti-slip mechanism of the present embodiment provides the anti-slip mechanism on the outer surface of the seat cloth and/or between the inner surface of the seat cloth and the seat body, increasing the friction between the child and the seat cloth, and the friction and fastening force between the seat cloth and the seat body, greatly reducing the forward displacement of the child with respect to the seat body when being impacted, thereby greatly reducing the pressure exerted by the safety belt on the abdomen of the child, and improving the safety for the child sitting in the child safety seat. At the same time, the anti-slip mechanism of this embodiment also has the following beneficial technical effects: it has simple structure, is convenient to produce and process, and it is not necessary for the mechanism of the seat body to be modified, so that no mold modification is required, and the production cost is low.

FIG. 10 schematically shows a child safety seat 2100 according to an embodiment of the present disclosure, and the child safety seat 2100 is applied with a safety belt protection device 2001 according to an embodiment of the present disclosure.

The child safety seat 2100 includes a seat body 2002 and a base (not shown in FIG. 10) for installing the seat body 2002. The seat body 2002 includes a seat portion 2002a and a backrest portion 2002b. Side wings on both sides of the seat portion 2002a may be folded upwards with respect to a middle part of the seat portion 2002a, and side wings on both sides of the backrest portion 2002b may be folded toward the front of the seat with respect to the middle part of the backrest portion 2002b, which is beneficial for the sitting position of the child in the seat body 2002. Depending on the different position of the child safety seat 2100 on a rear seat of the vehicle (for example, a car as described in the present embodiment), different safety belts 2008 (i.e., the safety belts mounted on the vehicles such as a cars, or in other words, car safety belts) will be used to restrain the child. For example, in FIG. 10, the child safety seat 2100 is fixed on the left rear seat of the vehicle, the safety belt 2008 at the left is engaged with a buckle on the vehicle seat through a belt buckle 2083 in the use state. The safety belt 2008 is divided by the belt buckle 2083 into a shoulder belt portion 2081 and a waist belt portion 2082. The shoulder belt portion 2081 extends across the left shoulder and the right waist of the child obliquely in a diagonal direction, and the waist belt portion 2082 extends across the waist of the child transversely.

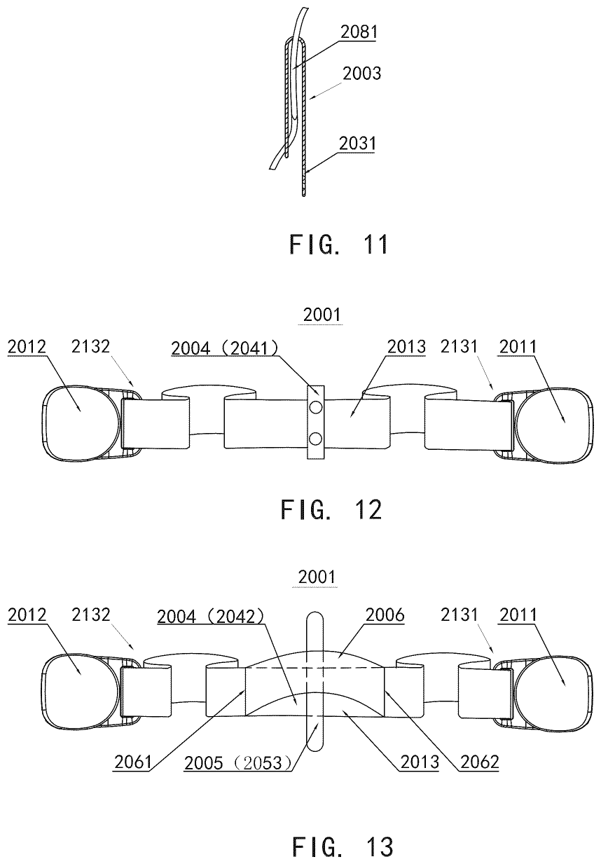

Referring to FIGS. 10 and 12, the safety belt protection device 2001 is installed on the seat body 2002 of the child safety seat 2100, and includes a first engaging element 2011, a second engaging element 2012 and a woven tape 2013.

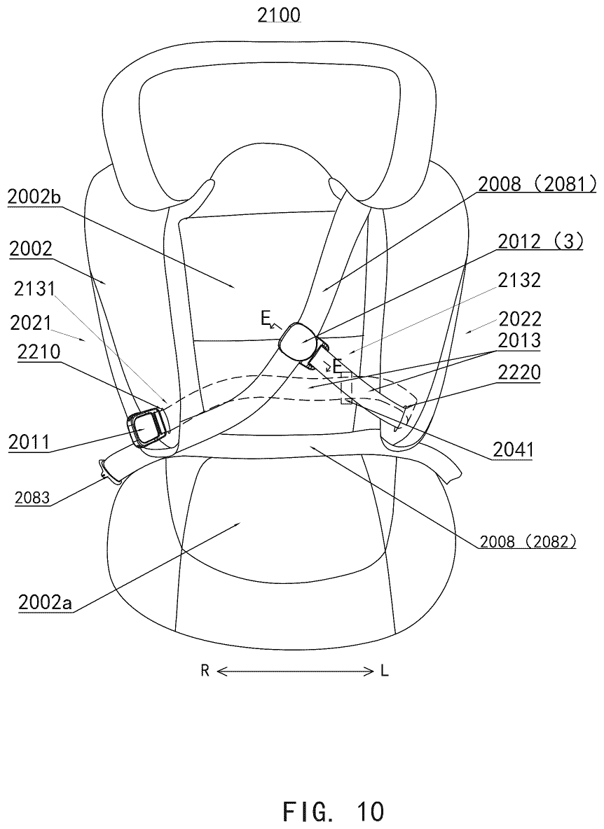

Each of the first engaging element 2011 and the second engaging element 2012 has a structure suitable for detachably connecting with the shoulder belt portion 2081. In some embodiments, the first engaging element 2011 and the second engaging element 2012 may use the hook 2003 shown in FIG. 11, for example. The hook 2003 has a U-shaped cross-section and is invertedly hung on the shoulder belt portion 2081 to be hooked with the shoulder belt portion 2081. The hook 2003 and the shoulder belt portion 2081 are very easy to engage and disassemble with each other. In some other embodiments, various implementations of the first engaging element 2011 and the second engaging element 2012 may also be provided as long as they are detachably engaged with the shoulder belt portion 2081. For example, in some embodiments, each of the first engaging element 2011 and the second engaging element 2012 is openable and closable annular sleeve, and a through hole in the annular sleeve allows the shoulder belt portion 2081 to pass through. For example, the annular sleeve is made of metal, plastic or cloth. When the annular sleeve is made of cloth, the annular sleeve is closed by, for example, buttons, magnetic buckles, three-rod buckles, zippers and the like. In FIG. 10, structures of the first engaging element 2011 and the second engaging element 2012 are the same, and it can be understood that in some embodiments, the structures of the first engaging element 2011 and the second engaging element 2012 may be different from each other.

The first engaging element 2011 and the second engaging element 2012 are connected by the woven tape 2013, and the woven tape 2013 is disposed around the seat body 2002, so that the first engaging element 2011 protrudes from a first side 2021 of the seat body 2002 (i.e., the right side of the seat body 2002 in FIG. 10), and the second engaging element 2012 protrudes from a second side 2022 of the seat body 2002 (i.e., the left side of the seat body 2002 in FIG. 10). In some embodiments, the inside of the seat body 2002 is provided with a guide groove or a guide hole structure for guiding the orientation of the woven tape 2013, and the first side 2021 of the seat body 2002 (e.g., the side wing of the backrest 2002b at the first side or the side wing of the seat portion 2002a at the first side) is provided with a first opening 2210, and the second side 2022 of the seat body 2002 (e.g., the side wing of the backrest portion 2002b at the second side or the side wing of the seat portion 2002a at the second side) is provided with a second opening 2220. A first end 2131 of the woven tape 2013 protrudes from the first opening 2210 and is connected to the first engaging element 2011, and a second end 2132 of the woven tape 2013 protrudes from the second opening 2220 and is connected to the second engaging element 2012. By pulling the first engaging element 2011 or the second engaging element 2012, the woven tape 2013 slides left and right with respect to the seat body 2002.

In some other embodiments, two ends of the woven tape 2013 may not protrude from the inside of the seat body 2002, but directly protrude from a periphery of the seat body 2002. For example, in some embodiments, some perforations or hooks for guiding the orientation of the woven tape 2013 may be provided on the outer circumferential surface of the backrest 2002b. The woven tape 2013 penetrates through the perforation or the hook, and two sides of the woven tape 2013 are separated from the backrest portion 2002b at two sides of the backrest portion 2002b. The first end of the woven tape 2013 protrudes from the periphery of the first side 2021 of the seat body 2002 and is connected with the first engaging element 2011, and the second end of the woven tape 2013 protrudes from the periphery of the second side 2022 of the seat body 2002 and is connected with the second engaging element 2012.

In some other embodiments, the two ends of the woven tape 2013 protrudes from both sides of the seat portion 2002a of the seat body 2002 instead of protruding from both sides of the backrest portion 2002b of the seat body 2002. For example, in some embodiments, a guide groove is provided inside the seat portion 2002a to guide the two ends of the woven tape 2013 to pass through two openings formed on both sides of the seat portion 2002a respectively, and then be connected with the first engaging element part 2011 and the second engaging element part 2012 respectively after protruding from the two sides of the seat portion 2002b.

It should be noted that, unless otherwise specified and limited, orientation terms such as “front”, “rear”, “left” and “right” in this embodiment correspond to directions such as “front”, “rear”, “left” and “right” as described when the child is sitting in the child safety seat 2100, and arrows L and R as shown are used to schematically show the directions of “left” and “right” respectively. These orientation terms are only used to make the description of the embodiments of the present disclosure clearer and are not used to improperly limit the protection scope of the present disclosure.

Referring to FIG. 10 again, when the woven tape 2013 is pulled on the second side (the left side of the child safety seat) 2022 of the seat body 2002, the first engaging element 2011 is retracted with respect to the seat body 2002, and the second engaging element 2012 is pulled with respect to the seat body 2002. The first engaging element 2011 abuts against a wall at the first opening 2210 to limit a length of the woven tape 2013 pulled by the second engaging element 2012. At the same time, the second engaging element 2012 is pulled out with respect to the seat body 2002 and is then detachably connected to the shoulder belt portion 2081, so as to apply a downward (including obliquely downward) traction to the shoulder belt portion 2081. The position where the second engaging element 2012 is engaged with the shoulder belt portion 2081 is close to a middle part of the shoulder belt portion 2081. When the vehicle is impacted, the woven tape 2013 pulls the shoulder belt portion 2081 through the second engaging element 2012, so as to apply a downward traction on the shoulder belt portion 2081 to make the shoulder belt portion 2081 approach the waist belt portion 2082, thereby effectively preventing an upper section of the shoulder belt portion 2081 from sliding upwards, preventing the shoulder belt portion 2081 from causing damage to the neck and face of the child, and improving the safety of the child when riding. When the child safety seat 2100 is disassembled from the vehicle seat, the connection relationship between the second engaging element 2012 and the shoulder belt portion 2081 is released, and the safety belt protection device 2001 is separated from the vehicle seat together with the child safety seat 2100, the safety belt 2008 may continue to be used for fixing an adult.

On the contrary, when the child safety seat 2100 is installed on the right side seat of the vehicle, the shoulder belt portion 2081 of the safety belt 2008 at the right side obliquely extends across the right shoulder and the left waist of the child in the diagonal direction. The woven tape 2013 is pulled on the first side (i.e., the right side of the child safety seat) 2021 of the seat body 2002, the second engaging element 2012 is retracted with respect to the seat body 2002, and the first engaging element 2011 is pulled with respect to the seat body 2002. The second engaging element 2012 abuts against a wall at the second opening 2220 to limit a length of the woven tape 2013 pulled by the first engaging element 2011. At the same time, the first engaging element 2011 is pulled out with respect to the seat body 2002 and is then detachably connected with the shoulder belt portion 2081, so as to apply a downward (including obliquely downward) traction on the shoulder belt portion 2081, thereby avoiding the shoulder belt portion 2081 from sliding upward and causing injury to the child.

In some embodiments, the first opening 2210 is provided with a structure for accommodating the first engaging element 2011, and the retracted first engaging element 2011 is accommodated in the first opening 2210. In addition, the second opening 2220 is provided with a structure for accommodating the second engaging element 2012, and the retracted second engaging element 2012 is accommodated in the second opening 2220, which is beneficial for the appearance, and may also prevent the child from colliding with the hanging first engaging element 2011 or a second engaging element 2012.

As can be seen from the above, when the child safety seat 2100 configured with the safety belt protection device 2001 according to the embodiment of the present disclosure uses the safety belt 2008 to restrict the movement of the child, according to the position of the child safety seat 2100 on the rear seat of the vehicle, the woven tape 2013 is pulled towards the left or right, so that one of the first engaging element 2011 and the second engaging element 2012 is retracted and accommodated, and the other is engaged with the shoulder belt portion 2081 so as to apply a downward traction on the shoulder belt portion 2081, and prevent the shoulder belt portion 2081 from sliding upwards and causing injury to the child. When the child safety seat 2100 is installed on different sides of the rear seat of the vehicle, it is not necessary to remove the safety belt protection device 2001, and thus the safety belt protection device 2001 may keep being installed on the child safety seat 2100 and will not be lost. In addition, when one of the first engaging element 2011 and the second engaging element 2012 is engaged with the shoulder belt portion 2081, the other is retracted and cannot be engaged with the shoulder belt portion 2081, thereby avoiding the problem that the safety belt protection device 2001 cannot form an effective traction on the shoulder belt portion 2081 due to the misuse of the user on the engaging element, and improving the safety and comfort of the child safety seat.

Referring to FIGS. 10, 12 to 16, in some embodiments, a first limiting structure 2004 is provided on the woven tape 2013, and the first limiting structure 2004 is located between the first engaging element 2011 and the second engaging element 2012. A second limiting structure 2005 is provided on the seat body 2002, and the second limiting structure 2005 cooperates with the first limiting structure 2004 to limit the pulling stroke of the woven tape 2013, that is, to limit the length of the woven tape 2013 pulled by the first engaging element 2011 and the second engaging element 2012. It can be understood that the first limiting structure 2004 and the second limiting structure 2005 are provided, so that the stroke of the woven tape 2013 is not be limited through the abutment between the first engaging element 2011 and the wall at the first opening 2210, and the abutment between the second engaging element 2012 and the wall at the second opening 2220.

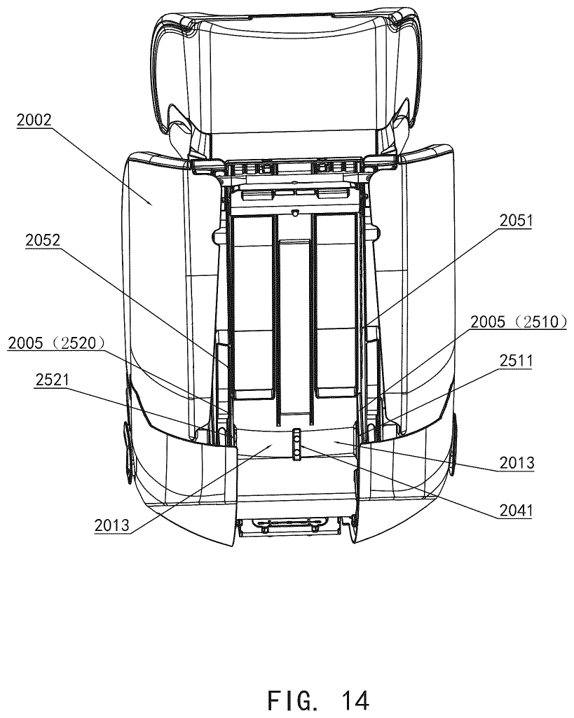

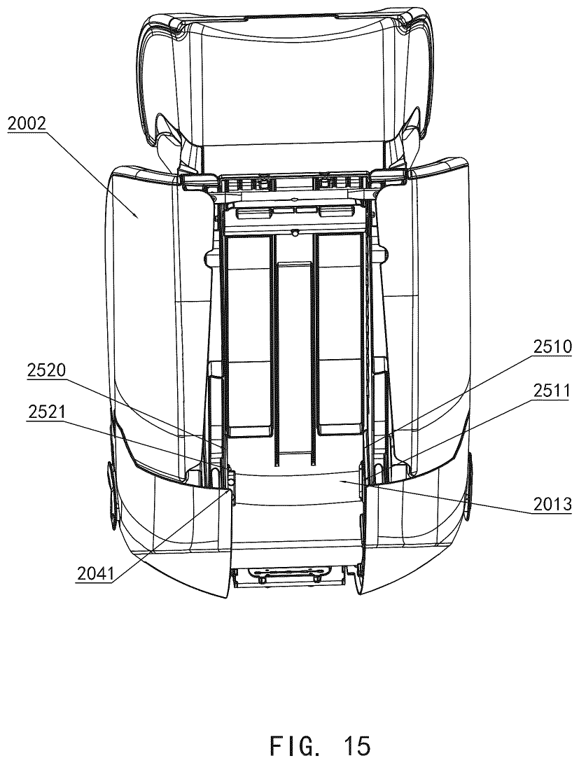

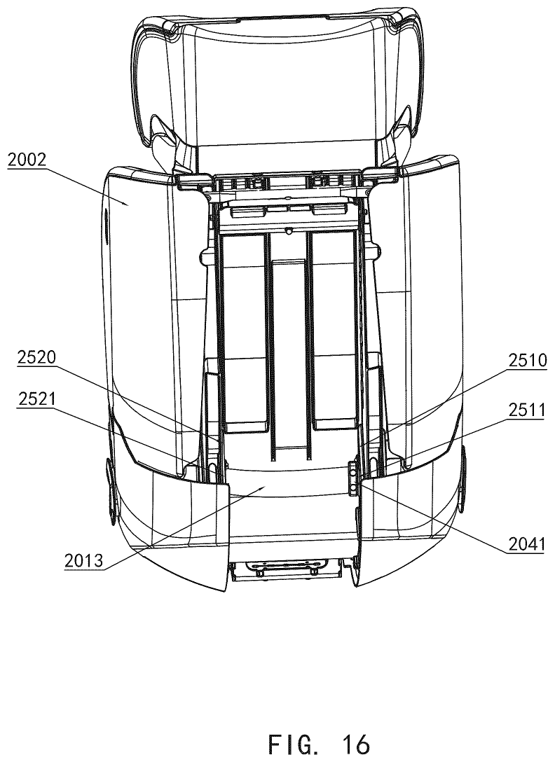

Referring to FIGS. 12, 14 to 16, an exemplary structure of the first limiting structure 2004 and the second limiting structure 2005 is shown. For the convenience of description, a frame structure of the seat body 2002 is shown in FIGS. 14 and 16, and the seat cloth and filling material of the seat body 2002 are not shown. The second limiting structure 2005 includes a first blocking surface 2510 and a second blocking surface 2520 that are disposed opposite to each other. For example, the first blocking surface 2510 is formed on a longitudinal beam 2051 of the frame structure of the seat body 2002, the second blocking surface 2520 is formed on a longitudinal beam 2052 of the frame structure of the seat body 2002, and the longitudinal beam 2051 and the longitudinal beam 2052 are disposed at an interval. The first blocking surface 2510 is provided with a first perforation 2511, and the second blocking surface 2520 is provided with a second perforation 2521. The first limiting structure 2004 includes a limiting block 2041 fixed on the woven tape 2013. The limiting block 2041 is fixed on the woven tape 2013 by a fastener (not labeled), for example. The fastener is a rivet, that is, to fix the limiting block 2041 with the woven tape 2013 by riveting. The first end 2131 of the woven tape 2013 extends forward through the first perforation 2511, the second end 2132 of the woven tape 2013 extends forward through the second perforation 2521, and the limiting block 2041 is located between the first blocking surface 2510 and the second blocking surface 2520. A volume of the limiting block 2041, or more specifically, a cross-sectional area of the limiting block in a direction perpendicular to an extending direction of the woven tape 2013 is substantially larger than an opening area of each of the first perforation 2511 and the second perforation 2521, so that the limiting block 2041 cannot enter the guide groove inside the seat body 2002 through the first perforation 2511 or the second perforation 2521, but can only move between the first blocking surface 2510 and the second blocking surface 2520. Referring to FIG. 15, when the first engaging element 2011 is retracted and the second engaging element 2012 is pulled out to engage with the shoulder belt portion 2081, the limiting block 2041 abuts against the second blocking surface 2520 to limit the length of the woven tape 2013 pulled by the second engaging element 2012. Referring to FIG. 16, when the second engaging element 2012 is retracted and the first engaging element 2011 is pulled out to engage with the shoulder belt portion 2081, the limiting block 2041 abuts against the first blocking surface 2510 to limit the length of the woven tape 2013 pulled by the first engaging element 2011. Compared with the abutment between the first engaging element 2011 and the first opening 2210 and the abutment between the second engaging element 2012 and the second opening 2220, the abutment between the limiting block 2041 and the first blocking surface 2510 or the second blocking surface 2520 may withstand greater traction.

In some embodiments, a first receiving groove is provided on the back of the first side 2021 of the seat body 2002, and a second receiving groove is provided on the back of the second side 2022 of the seat body 2002. The first receiving groove on the back of the first side 2021 is configured to accommodate the first engaging element 2011, and the second receiving groove on the back of the second side 2022 is configured to accommodate the second engaging element 2012. For example, when the child safety seat 2100 is in a non-use state, neither the first engaging element 2011 nor the second engaging element 2012 needs to be engaged with the shoulder belt portion 2081; at this time, the woven tape 2013 is withdrawn to a suitable position, the first engaging element 2011 is accommodated in the first receiving groove, and the second engaging element 2012 is accommodated in the second receiving groove. Alternatively, when the child safety seat 2100 is in the non-use state, the first engaging element 2011 is accommodated in the first opening 2210 and the second engaging element 2012 is accommodated in the second receiving groove, or the second engaging element 2012 is accommodated in the second opening 2220, and the first engaging element 2011 is accommodated in the first receiving groove.

FIG. 13 shows another exemplary structure of the first limiting structure 2004 and the second limiting structure 2005. An auxiliary belt 2006 is attached to the middle of the woven tape 2013, and the first end 2061 and the second end 2062 of the auxiliary belt 2006 are connected to the woven tape 2013, for example, by sewing. The first limiting structure 2004 includes a limiting ring 2042 surrounded by the woven tape 2013 and the auxiliary belt 2006. The second limiting structure 2005 includes a limiting column 2053, and the limiting column 2053 is disposed in a longitudinal direction perpendicular to the extending direction of the woven tape 2013, for example. A lower end of the limiting column 2053 is connected to the frame structure of the seat body 2002 through a connecting rod, or the lower end of the limiting column 2053 is directly fixed to the frame structure of the seat body 2002. An upper end of the limiting column 2053 is folded toward the frame structure of the seat body 2002, and a gap is formed between the upper end of the limiting column 2053 and the frame structure of the seat body 2002. The woven tape 2013 passes through the gap, so that the limiting column 2053 penetrates through the limiting ring 2042. In this way, when the woven tape 2013 is pulled out towards the left or right, two ends of the limiting ring 2042, that is, the first end 2061 and the second end 2062 of the auxiliary belt 2006, cooperate with the limiting column 2053 as a limiting end to limit the stroke of the woven tape 2053.

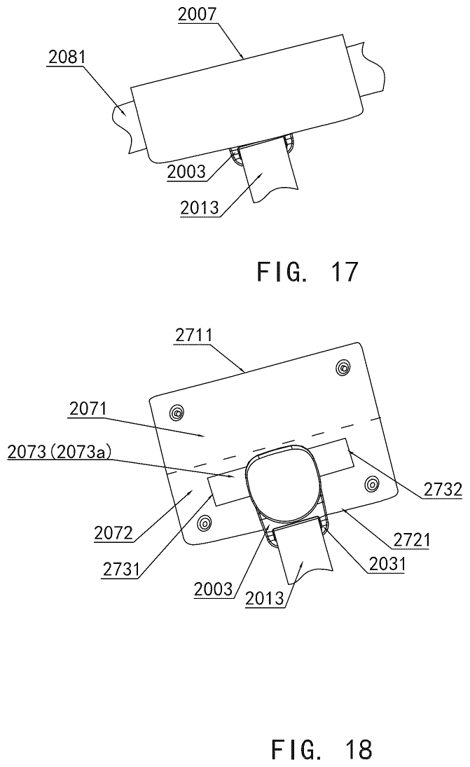

Referring to FIGS. 17 and 18, in some embodiments, the first engaging element 2011 and/or the second engaging element 2012 include a first sheath 2007 and the hook 2003 as mentioned above. At least a part of the hook 2003 is wrapped in the first sheath 2007, and the first sheath 2007 has a first channel (not shown) for the shoulder belt portion 2081 to pass through. A part of the shoulder belt portion 2081 penetrating through the first sheath 2007 is hooked with the hook 2003. The first sheath 2007 may provide a better anti-slip effect, thereby avoiding the hook 2003 from sliding along the shoulder belt portion 2081, and ensuring the reliable traction of the safety belt protection device 2001 on the shoulder belt portion 2081. The first sheath 2007 may also buffer the collision between the hook 2003 and the child, improving the comfort of the child when riding.

Referring to FIGS. 17 and 18, in some embodiments, the first sheath 2007 includes a first half part 2071 and a second half part 2072 that are connected with each other, a side portion 2711 of the first half part 2071 and a side portion 2721 of the second half part 2072, which are opposite to each other, are detachably connected. When the side portion 2711 of the first half part 2071 and the side portion 2721 of the second half part 2072 are connected opposite to each other, a channel sleeved on the shoulder belt portion 2081 for shoulder belt portion 2081 to pass through is defined corresponding to a closed state of the first sheath 2007. When the side portion 2711 of the first half part 2071 is separated from the side portion 2721 of the second half part 2072, the first sheath 2007 is removed from the shoulder belt portion 2081 corresponding to the opened state of the first sheath 2007. There are many ways of detachable connection between the side portion 2711 of the first half part 2071 and the side portion 2721 of the second half part 2072, for example, by means of snap connection, Velcro connection, or the like. It should be noted that the hook 2003 of the first engaging element 2011 and the hook 2003 of the second engaging element 2012 may share a first sheath 2007 to reduce the cost.

Referring to FIG. 18, in some embodiments, the first sheath 2007 is provided with a positioning structure 2073, and the hook 2003 is detachably connected to the positioning structure 2073. Providing the positioning structure 2073 is beneficial to fix the relative position of the hook 2003 and the first sheath 2007, and prevent the hook 2003 from escaping from the first sheath 2007 when the safety belt protection device 2001 pulls the shoulder belt portion 2081. The positioning structure 2073 includes, for example, a strip 2073a. A first end 2731 and a second end 2732 of the strip 2073a are connected to an inner surface of the first sheath 2007, for example, by sewing, and a middle part of the strip 2073a is hooked with the hook 2003.

In some embodiments, at least one of the first engaging element 2011 and the second engaging element 2012 is connected with the woven tape 2013 with an adjustable position, so that the height of the woven tape 2013 between the first engaging element 2011 and the second engaging element 2012 is adjusted according to the height of the child. There are many ways to adjust the length of the woven tape 2013 between the first engaging element 2011 and the second engaging element 2012. For example, in some embodiments, the woven tape 2013 includes an elastic tape.

Referring to FIG. 19, when the hook 2003 is used for the first engaging element 2011 and the second engaging element 2013, the hook 2003 is connected to the woven tape 2013 through its connecting portion 2031. The connecting portion 2031 is, for example, a three-rod buckle, a four-rod buckle, or the like, which is provided with an anti-slip structure at a position where the woven tape 2013 is engaged therewith, so as to prevent the undesired sliding between the hook 2003 and the woven tape 2013 when the safety belt protection device 2001 is used. The woven tape 2013 is provided with a plurality of indication areas 2136 corresponding to various height ranges of children, and the user can connect the corresponding indication area 2136 to the connecting portion 2031 according to the height of the child.

For example, in some embodiments, three indication areas 2136 are provided on each of the first end 2131 and the second end 2132 of the woven tape 2013, and are displayed in different colors. For example, “white” indicates a height of 105 cm to 125 cm, “orange” indicates a location of the woven tape corresponding to a height of 125 cm to 135 cm, and “blue” indicates a location of the woven tape corresponding to a height of 135 cm or more. Before the child sits on the child safety seat, the corresponding location of the woven tape 2013 is adjusted to the position engaging with the connecting portion 2031 according to the height of the child. The color of each of the indication areas 2136 is realized by a weaving method of changing the color of weft yarn, and can avoid wearing and fading. The color of each of the indication areas 2136 may also be realized by printing, which is easy to realize and has low cost. The display manner of each of the indication areas 2136 is not limited to the above examples, and in some embodiments, each of the indication areas 2136 may adopt a colored indicator light or other suitable manners.

It can be understood that in some embodiments, for example, only one of the first engaging element 2011 and the second engaging element 2012 is connected to the woven tape 2013 with an adjustable position, the above-mentioned indication areas 2136 are provided only at an end of the woven tape 2013.

Referring to FIG. 19 again, in some embodiments, a prompt area 2036 is provided on the hook 2003, and the prompt area 2036 may, for example, illustrate height ranges of children corresponding to colors of indication areas 2136 through a combination of patterns and words. These patterns and words used for explanation are pasted on the prompt area 2036 or printed on the prompt area 2036 using adhesive tapes.

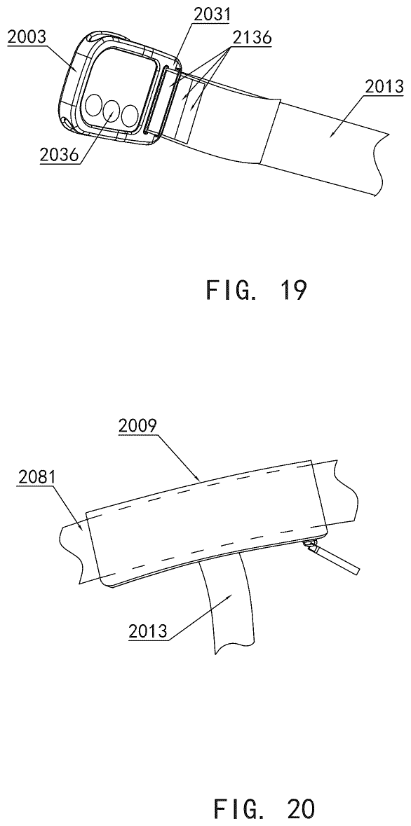

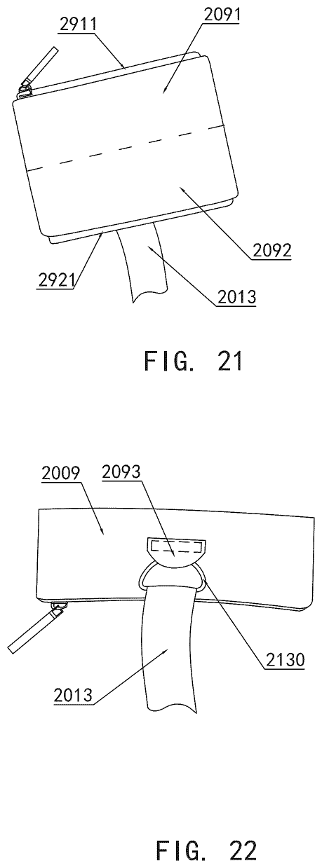

Referring to FIGS. 20 and 21, in some embodiments, at least one of the first engaging element 2011 and the second engaging element 2012 is a second sheath 2009, and the second sheath 2009 has a second channel for the shoulder belt portion 2081 to pass through. The second sheath 2009 may provide a better anti-slip effect, and is not easy to slide along the shoulder belt portion 2081, ensuring the reliable traction of the safety belt protection device 2001 on the shoulder belt portion 2081. The second sheath 2009 is in contact with the child, which is also conducive to improving the comfort of the child when riding.

In some embodiments, the second sheath 2009 includes a third half part 2091 and a fourth half part 2092 that are connected to each other, a side portion 2911 of the third half part 2091 and a side portion 2921 of the fourth half part 2092, which are opposite to each other, are detachably connected. When the side portion 2911 of the third half part 2091 and the side portion 2921 of the fourth half part 2092 are connected opposite to each other, a second channel sleeved on the shoulder belt portion 2081 is defined corresponding to a closed state of the second sheath 2009. When the side portion 2911 of the third half part 2091 is separated from the side portion 2921 of the fourth half part 2092, the second sheath 2009 is removed from the shoulder belt portion 2081 corresponding to an opened state of the second sheath 2009. There are many ways of detachable connection between the side portion 2911 of the third half part 2091 and the side portion 2921 of the fourth half part 2092, for example, through zipper connection, snap connection, Velcro connection and the like.

Referring to FIG. 22, in some embodiments, the second sheath 2009 is detachably connected to the woven tape 2013. In this way, the first engaging element 2011 and the second engaging element 2012 serves as the same second sheath 2009 to save the cost. For example, a connecting ring 2130 is provided at each of both ends of the woven tape 2013, and an openable connecting sleeve 2093 is provided on the second sheath 2009. According to the installation position of the child safety seat 2100, the first sheath 2009 is selectively connected to the connecting ring 2130 at one end of the woven tape 2013. The detachable connection manner of the second sheath 2009 and the woven tape 2013 is not limited to the above examples.

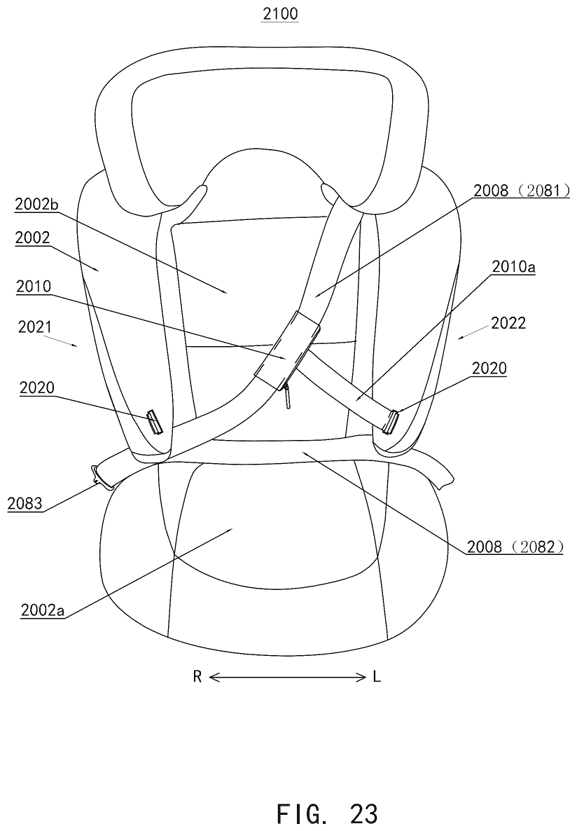

FIGS. 23 to 26 schematically show a child safety seat 2100 according to yet another embodiment of the present disclosure, and the child safety seat 2100 is applied with a safety belt protection device 2001 according to yet another embodiment of the present disclosure. In the case of no conflict, the structure of the seat body 2002 of the child safety seat 2100 may refer to the above description, which will not be repeated here.

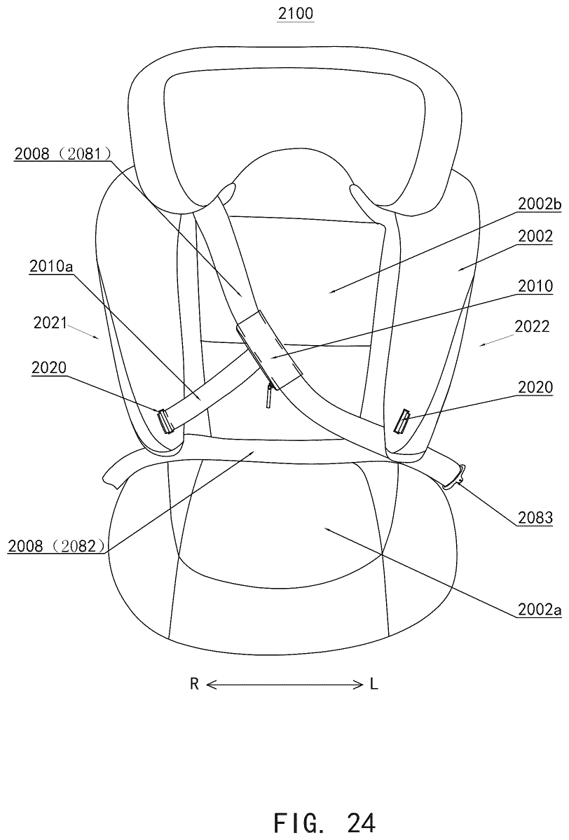

Referring to FIGS. 23 and 24, the safety belt protection device 2001 includes a third sheath 2010 and a first woven tape 2010a. The third sheath 2010 has a third channel for the shoulder belt portion 2081 to pass through, and the third sheath 2010 is connected to the first woven tape 2010a. According to different installation positions of the child safety seat 2100 on the rear seat of the vehicle, the first woven tape 2010a is selectively connected to the first side 2021 (for example, the side wing of the backrest 2002b at the first side or the side wing of the seat portion 2002a at the first side) or the second side 2022 (for example, the side wing of the backrest 2002b at the second side or the side wing of the seat portion 2002a at the second side) of the seat body 2002, the third sheath 2010 is detachably connected to the shoulder belt portion 2081 of the corresponding safety belt 2008, so that the third sheath 2010 can provide a better anti-slip effect and is not easy to slide along the shoulder belt portion 2081. Thus, the first woven tape 2010a applies a downward traction on the shoulder belt portion 2081 through the third sheath 2010, so that the shoulder belt portion 2081 approaches the waist belt portion 2082, which can effectively prevent the upper section of the shoulder belt portion 2081 from sliding upwards, thereby avoiding the shoulder belt portion 2081 from moving upward to hurt the child, and improving the safety of the child when riding. The contact of the third sheath 2010 with the child is also conducive to improving the comfort of the child when riding.

In FIG. 23, the child safety seat 2100 is installed on the rear left seat of the vehicle, and the safety belt 2008 at the left extends across the child in the child safety seat 2100 obliquely. At this time, the first woven tape 2010a is detachably connected to the side wing of the second side 2022 of the seat body 2002, more specifically, is detachably connected to the side wing of the backrest 2002b at the second side. In other embodiments, it is detachably connected to the side wing of the seat portion 2002a at the second side. The third sheath 2010 is detachably connected to the shoulder belt portion 2081 of the safety belt 2008. In FIG. 24, the child safety seat 2100 is installed on the rear right seat of the vehicle, and the safety belt 2008 at the right side extends across the child in the child safety seat 2100 obliquely. At this time, the first woven tape 2010a is detachably connected to the side wing of the first side 2021 of the seat body 2002, and the third sheath 2010 is detachably connected to the shoulder belt portion 2081 of the safety belt 2008. It can be understood that, in the child safety seat 2100 of this embodiment, the two side wings of the seat body 2002 (the side wing of the first side 2021 and the side wing of the second side 2022) share the same first woven tape 2010a and third sheath 2010, which facilitates to reduce the cost.

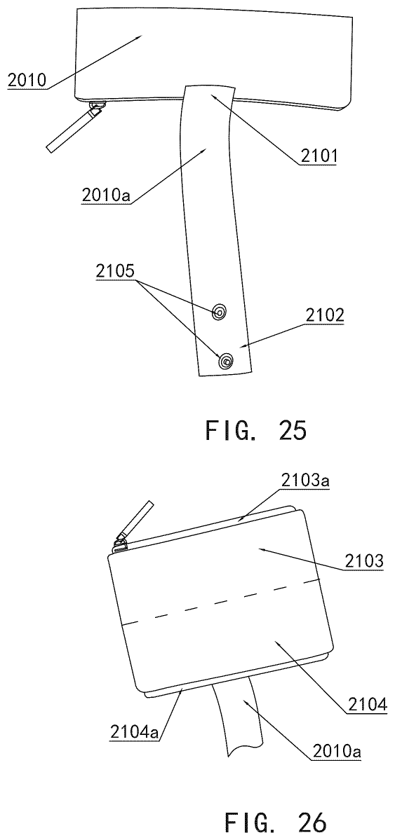

FIGS. 23 to 25 show an exemplary structure of the detachable connection between the first woven tape 2010a and the two side wings of the seat body 2002. As shown, each of the side wing of the first side 2021 and the side wing of the second side 2022 of the seat body 2002 is provided with a connecting structure 2020, and the connecting structure 2020 is, for example, a metal ring buckle sewn on the seat cloth of the seat body 2002. However, the present disclosure is not limited thereto. In some embodiments, the connecting structure 2020 is provided on only one of the side wing of the first side 2021 and the side wing of the second side 2022 of the seat body 2002, such as only on the side wing of the first side 2021. As shown in FIG. 25, the first end 2101 of the first woven tape 2010a is sewn together with the third sheath 2010, for example, and the second end 2102 of the first woven tape 2010a is provided with a snap structure 2105, a Velcro structure, or other connecting structures that corresponds thereto. When the second end 2102 of the first woven tape 2010a is connected by the snap structure 2105 or other structures, the second end 2102 of the first woven tape 2010a forms a sleeve passing through the metal ring buckle, so that the first woven tape 2010a is detachably connected to the connecting structure 2020 of the side wing at the first side 2021 or the side wing at the second side 2022 of the seat body 2002. The detachable connection manner between the first woven tape 2010a and the two side wings of the seat body 2002 is not limited to the above examples.

Referring to FIG. 26, in some embodiments, the third sheath 2010 includes a fifth half part 2103 and a sixth half part 2104 that are connected to each other, a side portion 2103a of the fifth half part 2103 and a side potion 2104a of the sixth half part 2104, which are opposite to each other, are detachably connected. When the side portion 2103a of the fifth half part 2103 and the side portion 2104a of the sixth half part 2104 are opposite to each other, a third channel sleeved on the shoulder belt portion 2081 for the shoulder belt portion 2081 to pass through is defined corresponding to a closed state of the third sheath 2010. When the side portion 2103a of the fifth half part 2103 is separated from the side portion 2104a of the sixth half part 2104, the third sheath 2010 is removed from the shoulder belt portion 2081 corresponding to an opened state of the third sheath 2010. There are many ways of detachable connection between the side portion 2103a of the fifth half part 2103 and the side portion 2104a of the sixth half part 2104, such as zipper connection, snap button connection, Velcro connection and the like.

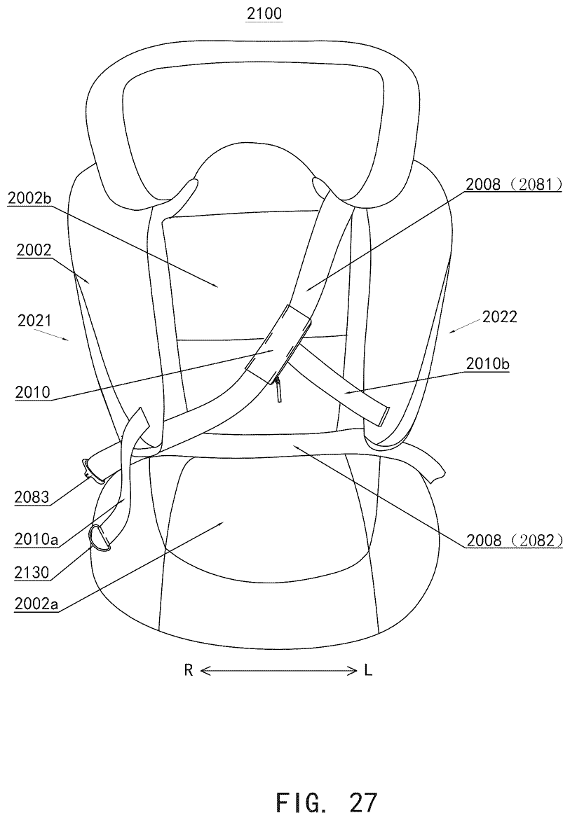

FIG. 27 schematically shows the child safety seat 2100 according to yet another embodiment of the present disclosure, and the child safety seat 2100 is applied with the safety belt protection device 2001 according to yet another embodiment of the present disclosure. In the case of no conflict, the structure of the seat body 2002 of the child safety seat 2100 may refer to the above description, which will not be repeated here.

Referring to FIG. 27, the safety belt protection device 2001 includes a first woven tape 2010a, a second woven tape 2010b and a third sheath 2010. The first woven tape 2010a is connected to the first side 2021 of the seat body 2002 (for example, the side wing of the first side of the backrest portion 2002b or the side wing of the first side of the seat portion 2002a), and the first woven tape 2010a is, for example, sewn on the seat cloth of the seat body 2002. The second woven tape 2010b is connected to the second side 2022 of the seat body 2002 (for example, the side wing of the second side of the backrest 2002b or the side wing of the second side of the seat portion 2002a), and the second woven tape 2010b is, for example, sewn on the seat cloth of the seat body 2002. According to the different installation positions of the child safety seat 2100 on the rear seat of the vehicle, the third sheath 2010 is selectively detachably connected to the first woven tape 2010a or the second woven tape 2010b, so as to apply a downward traction on the shoulder belt portion 2081 of the corresponding safety belt 2008, and prevent the shoulder belt portion 2081 from moving up to hurt the child.

In FIG. 27, the third sheath 2010 is separated from the first woven tape 2010a and is detachably connected to the second woven tape 2010b. At this time, the child safety seat 2100 is installed on the rear left seat of the vehicle, and the second woven tape 2010b applies a traction on the shoulder belt portion 2081 of the safety belt 2008 at the left side through the third sheath 2010 in a downward and leftward direction. It can be understood that when the child safety seat 2100 is installed on the rear right seat of the vehicle, the third sheath 2010 is separated from the second woven tape 2010b, so that the third sheath 2010 is detachably connected to the first woven tape 2010a. At this time, the first woven tape 2010a applies a traction on the shoulder belt portion 2081 of the safety belt 2008 at the right side through the third sheath 2010 in a downward and rightward direction (referring to FIG. 24). In this embodiment, the first woven tape 2010a and the second woven tape 2010b share the same third sheath 2010, thereby reducing the cost.

For the structure of the third sheath 2010 in the safety belt protection device 2001 shown in FIG. 27, and the detachable connection structure between the third sheath 2010 and the first woven tape 2010a and the second woven tape 2010b, please referring to the structure of the second sheath 2009 and the detachable connection structure between the second sheath 2009 and the woven tape 2013 shown in FIGS. 20 to 22, which are not repeated herein.

When the safety belt protection device provided by the embodiment of the present disclosure is applied to the child safety seat, according to the position of the child safety seat on the rear seat of the vehicle, the woven tape is pulled towards the left or right, so that one of the first engaging element and the second engaging element is accommodated, and the other is engaged with the shoulder belt of the vehicle safety belt, so as to apply a downward traction on the shoulder belt portion, and prevent the shoulder belt portion from sliding upwards and causing injury to the child. When the child safety seat is installed on different sides of the rear seat of the child, it is not necessary to remove the safety belt protection device, and thus the safety belt protection device may keep being installed on the child safety seat and will not be lost.

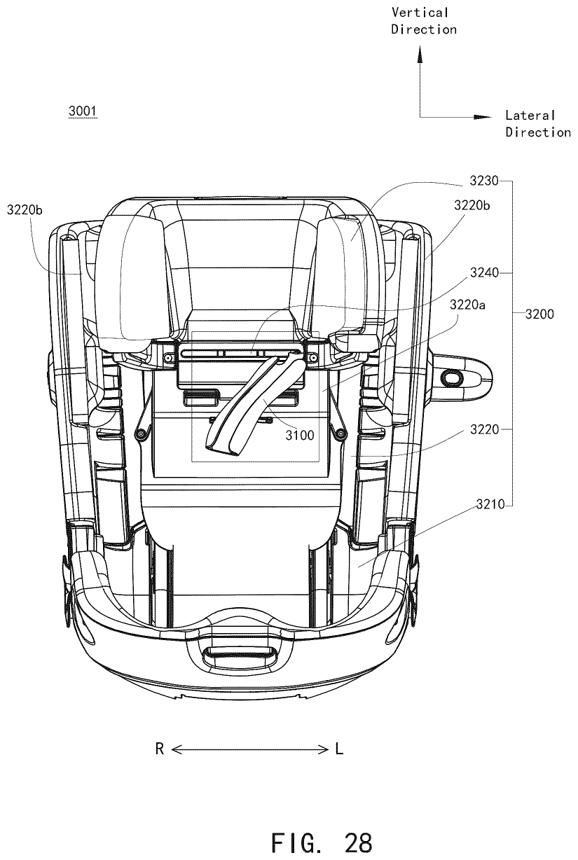

A child safety seat 3001 according to an embodiment of the present disclosure is generally described with reference to FIG. 28. The child safety seat 3001 includes a seat body 3200 and a safety belt protection device 3100 installed on the seat body 3200.

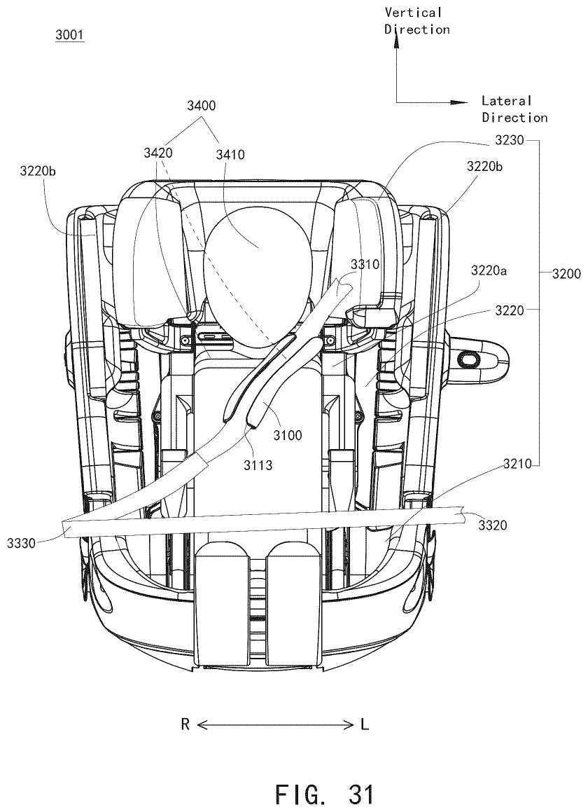

The seat body 3200 is configured to carry the child 3400 (see FIG. 31). The seat body 3200 includes an upper end and a lower end which are spaced apart from each other. The seat body 3200 is configured that when the child 3400 is properly seated on the child safety seat 3001, a head of the child 3400 is positioned near the upper end than the lower end. For example, the seat body 3200 includes a seat portion 3210, a backrest portion 3220 and a headrest portion 3230, for the child 3400 to sit stably. The child safety seat 3001 is placed on the vehicle seat (not shown). The vehicle seat is usually the rear seat of the car, including the rear seat on the left side and the rear seat on the right side. The child safety seat 3001 is fixed to the vehicle seat through the safety belt 3300 of the vehicle, and the connection manner of the safety belt 3300 will be described in detail later. The seat portion 3210 is positioned at the upper end of the seat body 3200, such as connected to the upper end of the backrest portion 3220, for carrying the head 3410 of the child 3400. When the child 3400 is seated on the child safety seat 3001, the backrest surface 3220a of the backrest portion 3220 serves to support a back of the child 3400. The backrest portion 3220 includes a pair of side wings 3220b which are spaced apart from each other, and the backrest surface 3220a is positioned between the pair of side wings 3220b.

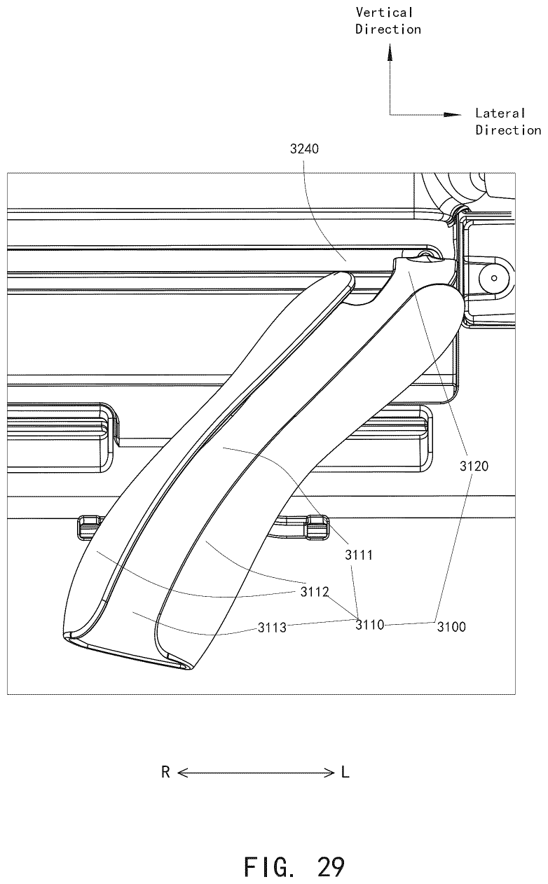

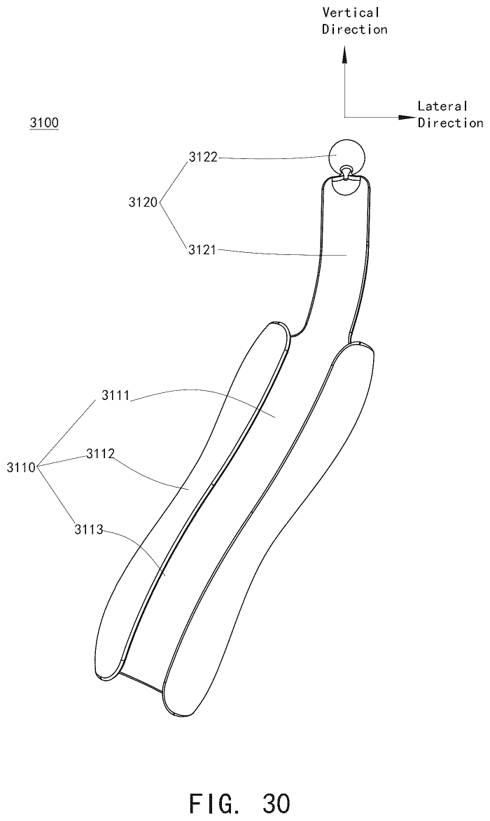

The specific structure of the safety belt protection device 3100 will be described with reference to FIGS. 29 and 30. The safety belt protection device 3100 includes a guiding portion 3110 and a connecting portion 3120.

The guiding portion 3110 receives a part of the safety belt 3300. The guiding portion 3110 is generally formed in a groove shape opened towards the front side of the child safety seat 3001. The guiding portion 3110 includes a bottom portion 3111, at least one side portion 3112 and a channel 3113.

The bottom portion 3111 is adjacent to the child safety seat 3001. In the embodiment shown in FIG. 29, the bottom portion 3111 extends substantially and obliquely downwards vertically. It should be understood, however, that the safety belt protection device 3100 has a certain flexibility and the shape and position of any of various parts can be changed to accommodate the shape and position of the safety belt 3300. Therefore, in other embodiments, the bottom portion 3111 extends in other directions.

The side portion 3112 protrudes from a transverse edge of the bottom portion 3111 in a direction away from the backrest surface 3220a of the child safety seat 3001 and is curved towards a transverse center of the bottom portion 3111. In one embodiment, two side portions 3112 are provided opposite to each other in a transverse direction, and a transverse distance between the two side portions 3112 is greater than half of a transverse dimension of the bottom portion 3111. It should be understood, however, that in other embodiments, the transverse distance between the two side portions 3112 is greater or less. Moreover, in other embodiments, only one side portion 3112 is provided.

A channel 3113 is formed between the bottom portion 3111 and the side portion 3112 along which the safety belt 3300 extends through the safety belt protection device 3100. A transverse dimension of the channel 3113 is slightly larger than a width of the safety belt 3300, so that the safety belt 3300 passes through the channel 3113 easily. In this embodiment, the channel 3113 is formed over the entire vertical length of the bottom portion 3111. It should be understood that in other embodiments, the channel 3113 may be formed only on a part of a length of the bottom portion 3111.

The connecting portion 3120 connects the guiding portion 3110 to the child safety seat 3001. The connecting portion 3120 is configured to move transversely with respect to the child safety seat 3001, so that the guiding portion 3110 is selectively located at the left shoulder or the right shoulder of the child 3400, which will be described in detail below.

The connecting portion 3120 includes a ball portion 3122 and an extension 3121. The ball portion 3122 is slidably engaged to a sliding slot 3240 of the child safety seat 3001. The extension 3121 is connected between the guiding portion 3110 and the ball portion 3122. More specifically, the sliding slot 3240 is a transverse slot provided on the child safety seat 3001, for example, is provided on the headrest portion 3230. Therefore, when the height of the headrest portion 3230 is adjusted relative to the seat portion 3210 or the backrest portion 3220, the sliding slot 3240 and the safety belt protection device 3100 engaged on the sliding slot 3240 are simultaneously adjusted. The ball portion 3122 and the guiding portion 3110 are respectively located on opposite sides of the sliding slot 3240. For example, the ball portion 3122 is located at a rear side of the sliding slot 3240 (i.e., when the child 3400 is seated on the child safety seat 3001, the side of the child safety seat 3001 which faces away from the child 3400), and the guiding portion 3110 is located at a front side of the sliding slot 3240 (i.e., when the child 3400 is seated on the child safety seat 3001, the side of the child safety seat 3001 which faces the child 3400). The extension 3121 passes through the sliding slot 3240 to connect the ball portion 3122 and the guiding portion 3110. In one embodiment, the sliding slot 3240 is provided, for example, on the backrest surface 3220a or at least one of the side wings 3220b of the backrest portion 3220.

A diameter of the ball portion 3122 is greater than a width of the sliding slot 3240 and is locked at any end of the sliding slot 3240. In the embodiment shown in FIG. 29, the ball portion 3122 is locked on the left end of the sliding slot 3240, that is, at the left shoulder of the child 3400 (see FIG. 31).

In one embodiment, the ball portion 3122, the extension 3121 and the guiding portion 3110 are formed as an integral structure, for example, an integral structure that is injection molded, so as to simplify the manufacturing process. In one embodiment, the guiding portion 3110 is made of energy-absorbing material, for example, cloth covered with foam, or thermoplastic material such as TPE, TPR, TPU, TPV, TPO, TPEE, etc., or silicone.

The use of the safety belt protection device 3100 will be described with reference to FIG. 31.

In use, the child 3400 sits in the child safety seat 3001 with his/her head 3410 at the headrest portion 3230 and his/her body at the seat portion 3210 and the backrest portion 3220. A first end 3310 of the safety belt 3300 of the vehicle is connected to a vehicle seat (not shown). The vehicle seat is usually located behind the child safety seat 3001, but the present disclosure is not limited thereto. Taking FIG. 31 as an example, the child safety seat 3001 is fixed to the left rear seat of the vehicle. When in use, the safety belt 3300 on the left side of the vehicle is connected to an insert buckle (not shown) on the vehicle seat through a belt buckle (not shown). The belt buckle divides the safety belt 3300 into a shoulder belt and a waist belt. The shoulder belt diagonally crosses the left shoulder and the right waist of the child 3400, and the waist strap horizontally crosses the waist of child 3400. The shoulder belt of the safety belt 3300 extends from the first end 3310 to a shoulder 3420 of the child 3400 around or through the child safety seat 3001, and then obliquely extends downward to a side of the waist of the body of the child 3400, and is connected to the vehicle seat (not shown) by the belt buckle at the side of the waist of the body of the child 3400. The waist belt of the safety belt 3300 further extends transversely to a second end 3320 at the other side of the waist of the body of the child 3400, and is connected to the vehicle seat (not shown) at the second end 3320. Therefore, it can be understood that the upper portion of the shoulder belt of the safety belt 3300 extends around one shoulder 3420 of the child 3400 obliquely. Without the safety belt protection device 3100, when the vehicle is impacted, the shoulder belt of the safety belt 3300 may slip onto the neck of the child 3400, resulting in neck strangulation or facial injury to the children 3400.

Thanks to the safety belt protection device 3100 of the embodiment of the present disclosure, a part of the safety belt 3300 corresponding to the shoulder 3420 passes through the channel 3113. Due to the obstruction of the safety belt protection device 3100, the safety belt 3300 will not slide from the shoulder 3420 to the neck easily. Moreover, the safety belt protection device 3100 may serve as a buffer device between the safety belt 3300 and the child 3400 to reduce the impact force of the child 3400 in a collision accident, thereby enhancing the safety performance.

In the embodiment shown in FIG. 31, the child safety seat 3001 is installed on the left side seat of the vehicle. In such a case, the first end 3310 and the second end 3320 of the safety belt 3300 are located on the left side of the child 3400 (FIG. 31 shows the child 3400 and the child safety seat 3001 in a mirrored way, so that the left side of the child 3400 refers to the right side of the child 3400), the belt buckle is located on the right side of the child 3400 (i.e., the left side of FIG. 31), and thus the safety belt 3300 extends around the left shoulder 3420 of the child 3400. In this case, the connecting portion 3120 of the safety belt protection device 3100 is configured to move to the left side of the child safety seat 3001 (i.e., the left end of the sliding slot 3240), and the guiding portion 3110 may extend obliquely from the upper left to the lower right to adapt to the extending direction of the safety belt 3300.

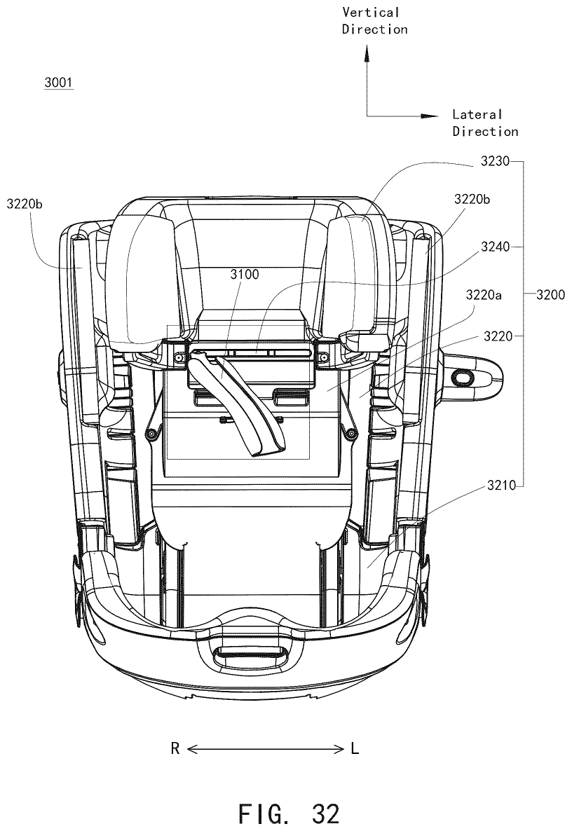

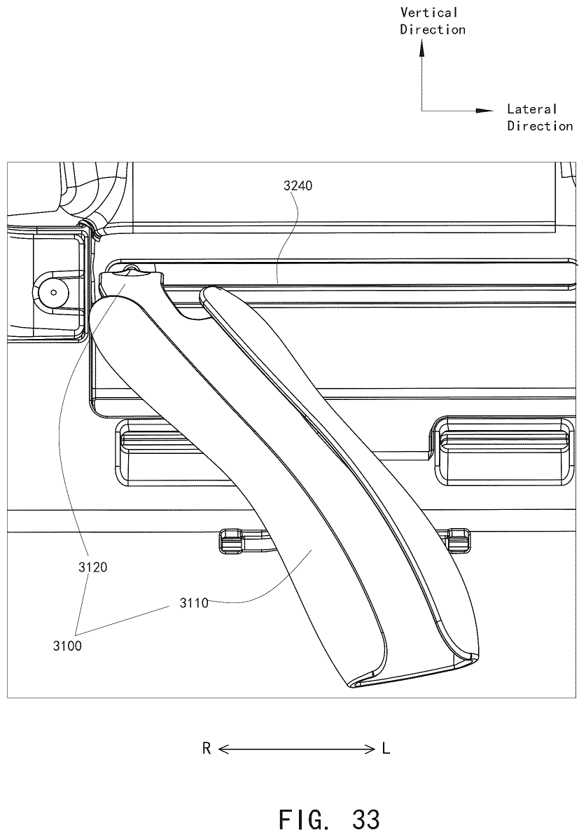

Referring to FIGS. 32 and 33, FIGS. 32 and 33 show a situation that the safety belt protection device 3100 is located on the right side of the child safety seat 3001. In this case, the extending direction of the safety belt 3300 refers to a horizontal mirror of the embodiment shown in FIG. 31, that is, the safety belt extends obliquely around the right shoulder 3420 of the child 3400.

In order to adapt to the extending direction of the safety belt 3300, the connecting portion 3120 of the safety belt protection device 3100 moves to the right side of the child safety seat 3001 (i.e., the left side in FIGS. 32 and 33), that is, slides to the right end of the sliding slot 3240. The guiding portion 3110 extends obliquely from the upper right to the lower left to conform to the extending direction of the safety belt 3300.

It can be seen that, according to the safety belt protection device 3100 of the present disclosure, a single safety belt protection device 3100 is provided to adapt to the use requirements of the left connection (FIGS. 28, 29 and 31) and the right connection (FIGS. 32 and 33) of the safety belt 3300. Therefore, the safety belt protection device 3100 and the child safety seat 3001 having the same have improved flexibility of use.

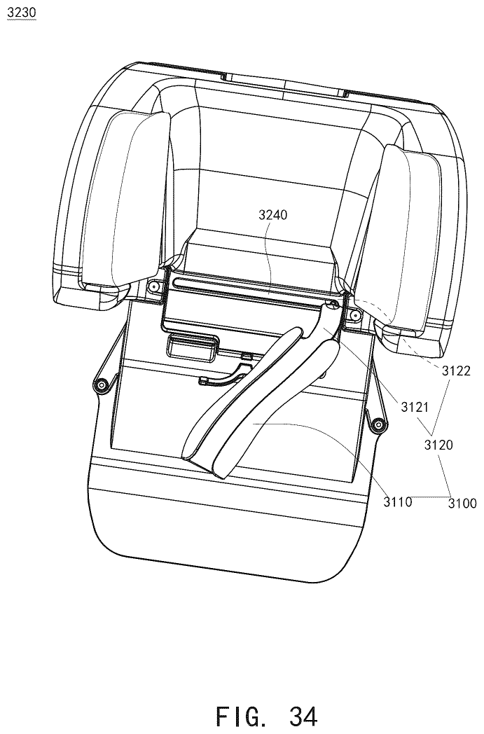

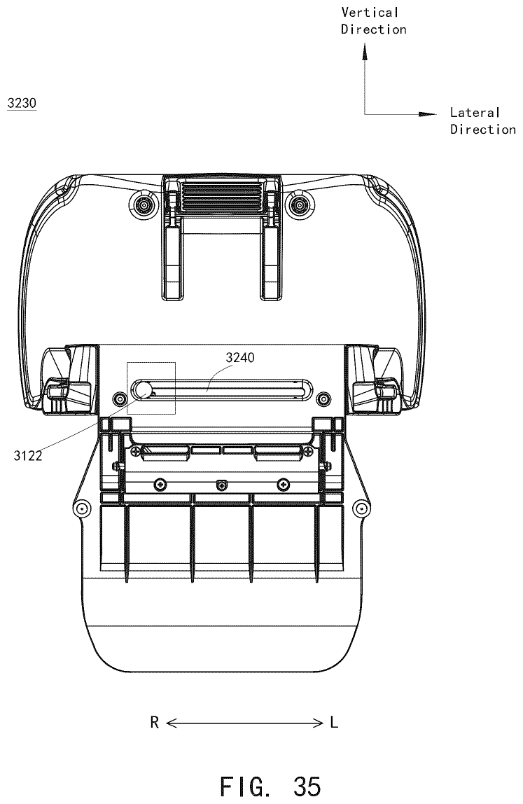

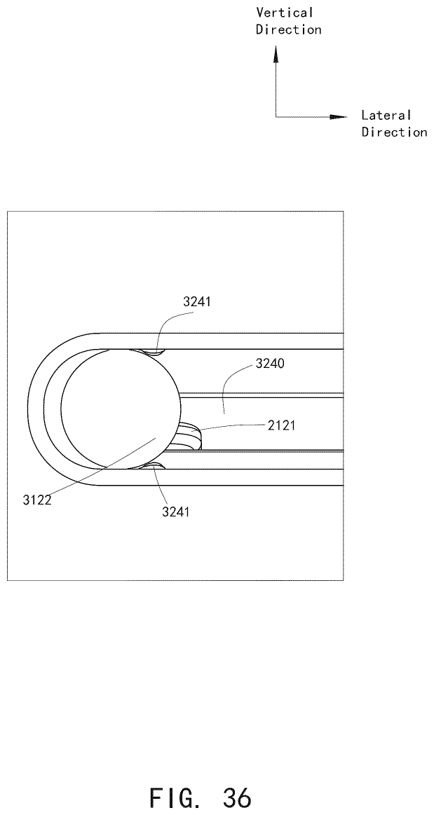

Referring to FIGS. 34 and 35, the connection between the safety belt protection device 3100 and the child safety seat 3001 is further shown. It can be clearly seen that the guiding portion 3110 and the ball portion 3122 of the safety belt protection device 3100 are located on each of two sides of the sliding slot 3240.

A protrusion 3241 of the sliding slot 3240 is described with reference to FIG. 36. The sliding slot 3240 is provided with at least one protrusion 3241 to limit the ball portion 3122 at either end of the sliding slot 3240. The protrusion 3241 extends vertically from at least one of an upper transverse edge and a lower transverse edge of the sliding slot 3240 towards the inside of the sliding slot 3240, and a spacing is formed between the protrusion 3241 and either end of the sliding slot 3240. In one embodiment, a pair of protrusions 3241 are provided near each of the transverse end of the sliding slot 3240 (only one pair of protrusions are shown in FIG. 36), and each pair of protrusions 3241 are respectively disposed on each of two vertical sides of the sliding slot 3240 and opposite to each other.

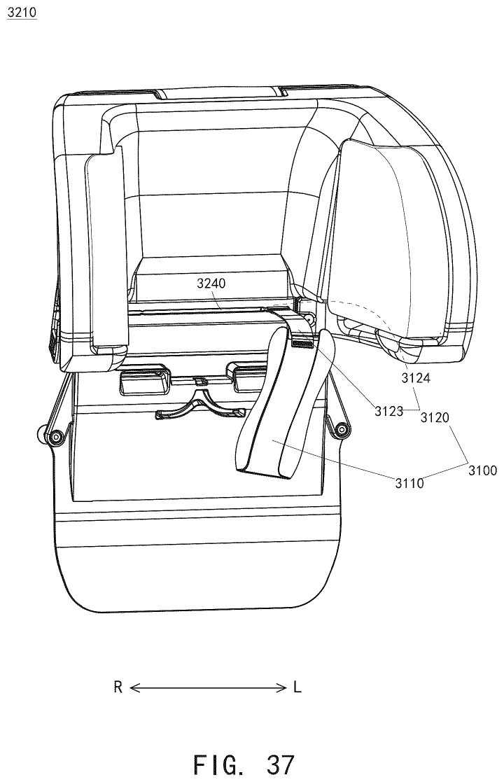

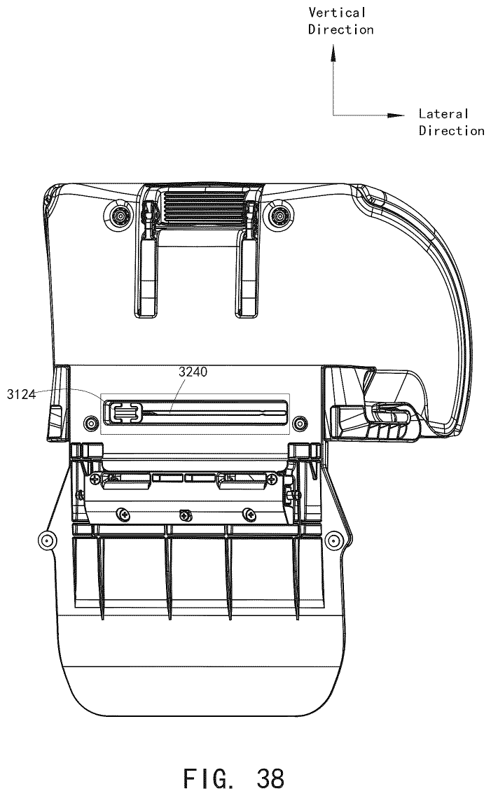

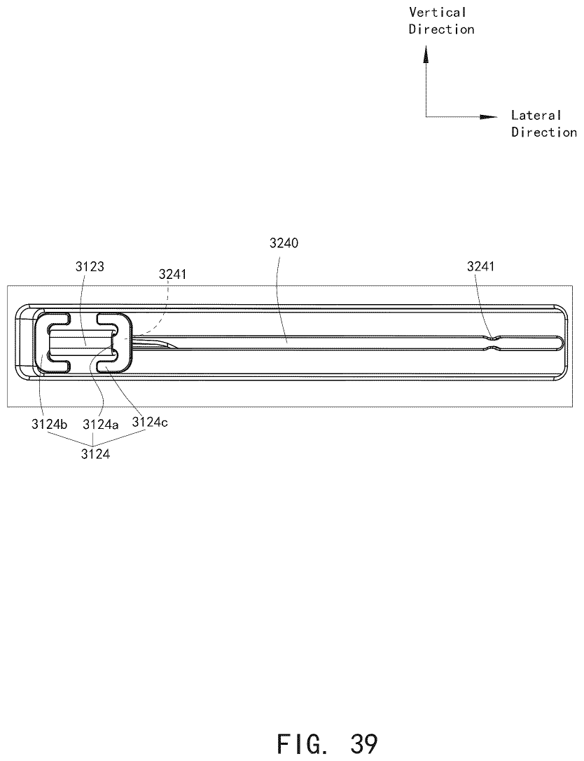

Another embodiment of a safety belt protection device 3100 according to the present disclosure is described with reference to FIGS. 37 and 38. The guiding portion 3110 of another embodiment is substantially the same as that of the previous embodiment, but the connecting portion 3120 has a different structure.

In another embodiment, the connecting portion 3120 includes an engagement element 3124 and a connecting belt 3123. The engagement element 3124 is slidably engaged to the sliding slot 3240 of the child safety seat 3001. More specifically, the engagement element 3124 is located at a rear side of the sliding slot 3240 of the seat body 3200.

The connecting belt 3123 is connected between the guiding portion 3110 and the engagement element 3124 and passes through the sliding slot 3240. For example, the connecting belt 3123 is a fabric, one end of which is sewn to the guiding portion 3110, and the other end of which is sewn to the connecting belt 3123 itself after extending around the engagement element 3124.

The specific structure of the engagement element 3124 is described with reference to FIG. 39. The engagement element 3124 has a general three-rod shape, that is, a rectangle with a horizontal line in the middle. Specifically, the engagement element 3124 includes a first transverse portion 3124a, two second transverse portions 3124c that are opposite to each other, and two vertical portions 3124b that are opposite to each other. The first transverse portion 3124a is located at a vertical middle of the engagement element 3124, and the connecting belt 3123 extends around the first transverse portion 3124a. The second transverse portion 3124c is located on each of both vertical sides of the first transverse portion 3124a, and each of the second transverse portions 3124c extends across the entire transverse dimension of the engagement element 3124 or is interrupted at the transverse middle. An embodiment in which the second transverse portion 3124c is interrupted in the transverse middle is shown in FIG. 39. Each of the vertical portions 3124b is connected at the middle thereof to one end of the first transverse portion 3124a, and at both ends thereof to one end of one of the second transverse portions 3124c, respectively.

In another embodiment, at least one protrusion 3241 is provided in the sliding slot 3240 to lock the engagement element 3124 at either end of the sliding slot 3240 More specifically, a length of the vertical portions 3124b of the engagement element 3124 is greater than a vertical width of the sliding slot 3240, allowing the engagement element 3124 to slide along the sliding slot 3240 without passing through the sliding slot 3240. A distance between the protrusion 3241 and the edge of the sliding slot 3240, or a distance between the two opposite protrusions 3241, is slightly smaller than the width of the first transverse portion 3124a of the engagement element 3124, allowing the engagement element 3124 to be forcefully pulled through the position of the protrusion(s) 3241, such that the engagement element 3124 is switchable between the left and right ends of the sliding slot 3240.

According to an embodiment of the present disclosure, the headrest portion 3230 of the seat body 3200 is configured to adjust its position with respect to the seat portion 3210, for example, moving up and down with respect to the seat portion 3210 to adapt to the height of the child 3400.

The safety belt protection device 3100 is connected to the seat portion 3210 or the headrest portion 3230. For example, FIGS. 34 and 35 show an embodiment in which the safety belt protection device 3100 is connected to the headrest portion 3230. In such an embodiment, when the position of the headrest portion 3230 is adjusted with respect to the seat portion 3210, the position of the safety belt protection device 3100 is adjusted along with the headrest portion 3230, thereby automatically adapting to the height of the child 3400 to be located at the shoulder 3420 of the child 3400 (see FIG. 31). It should be understood that in other embodiments, the safety belt protection device 3100 may be connected to the seat portion 3210.

It should be understood that although the safety belt protection device is described in the present disclosure by taking the child safety seat as an example, the safety belt protection device may also be applied to other devices such as other seats.

According to an embodiment, an anti-slip mechanism, wherein the anti-slip mechanism is disposed on at least one of a seat cloth and a seat body of a child safety seat to prevent the seat cloth of the child safety seat from sliding with respect to an object that contacts with the seat cloth.

According to an embodiment, the anti-slip mechanism includes: a first anti-slip portion disposed on at least one of an outer surface of the seat cloth, an inner surface of the seat cloth, and the seat body.

According to an embodiment, the first anti-slip portion is a single component provided on the seat cloth, or includes a plurality of components evenly distributed on the seat cloth.

According to an embodiment, the first anti-slip portion is sewn, pasted or printed on the seat cloth.

According to an embodiment, the first anti-slip portion is at least disposed on the inner surface of the seat cloth, and is disposed on a buttock area of the seat cloth of the child safety seat.

According to an embodiment, first anti-slip portion is disposed on the outer surface of the seat cloth, and is disposed on a buttock area and/or a leg area of the seat cloth of the child safety seat.

According to an embodiment, the leg area includes a lower leg area and/or a side leg area.

According to an embodiment, the first anti-slip portion is made of a material having greater friction than the seat cloth.

According to an embodiment, the first anti-slip portion is a silicone sheet or a rubber sheet.

According to an embodiment, a plurality of ventilation holes are distributed on the first anti-slip portion.

According to an embodiment, embossed patterns are provided on a surface of the first anti-slip portion.

According to an embodiment, the first anti-slip portion is provided on an area of the seat body corresponding to a buttock area of the seat cloth.

According to an embodiment, the anti-slip mechanism includes: a second anti-slip portion for positioning the seat cloth on the seat body of the child safety seat covered by the seat cloth.

According to an embodiment, the second anti-slip portion includes: one or more connecting elements disposed on the seat cloth; and one or more fitting elements disposed at a corresponding position on the seat body.

According to an embodiment, the connecting elements and the fitting elements are disposed centrally or symmetrically with respect to a longitudinal central axis of the child safety seat.

According to an embodiment, the one or more connecting elements are disposed at an edge of the seat cloth.

According to an embodiment, one of the connecting element and the fitting element is a clamping opening or a clamping slot or a cloth loop; the other of the connecting element and the fitting element is a hook or a fixing buckle.

According to an embodiment, the one or more connecting elements are disposed on a buttock area of the seat cloth, and the one or more fitting elements are disposed on an area of the seat body corresponding to the buttock area.

According to an embodiment, a safety belt protection device installed to a seat body of a child safety seat, wherein the safety belt protection device is configured to engage at least a part of a safety belt and limit movement of the safety belt with respect to the child safety seat.

According to an embodiment, a child safety seat is provided with the anti-slip mechanism of the present disclosure.

According to an embodiment, the safety belt protection device includes: a first engaging element; a second engaging element; a woven tape, through which the first engaging element and the second engaging element are connected; wherein the woven tape is adapted to be disposed around the seat body, such that the first engaging element protrudes from a first side of the seat body, and the second engaging element protrudes from a second side of the seat body; and such that via the woven tape is pulled, one of the first engaging element and the second engaging element is retracted with respect to the seat body, and the other of the first engaging element and the second engaging element is pulled out with respect to the seat body, wherein the first engaging element or the second engaging element that is pulled out is configured to be detachably connected with a shoulder belt portion of the safety belt, so as to apply a downward traction on the shoulder belt portion.

According to an embodiment, the woven tape is provided with a first limiting structure, and the first limiting structure is located between the first engaging element and the second engaging element and is adapted to cooperate with a second limiting structure on the seat body to limit a pulling stroke of the woven tape.

According to an embodiment, the limiting structure includes a first blocking surface and a second blocking surface that are disposed opposite to each other, the first blocking surface is provided with a first perforation, and the second blocking surface is provided with a second perforation; the first limiting structure includes a limiting block fixed on the woven tape, the woven tape passes through the first perforation and the second perforation, and the limiting block is located between the first blocking surface and the second blocking surface.

According to an embodiment, a cross-sectional area of the limiting block in a direction perpendicular to an extending direction of the woven tape is larger than an opening area each of the first perforation and the second perforation.

According to an embodiment, an auxiliary belt is attached to a middle of the woven tape, and two ends of the auxiliary belt are respectively connected to the woven tape; the first limiting structure includes a limiting ring surrounded by the woven tape and the auxiliary belt; the second limiting structure includes a limiting column, and the limiting column penetrates through the limiting ring.

According to an embodiment, at least one of the first engaging element and the second engaging element includes a hook for being hooked with the shoulder belt portion.

According to an embodiment, at least one of the first engaging element and the second engaging element further includes a first sheath, at least a part of the hook is wrapped in the first sheath, and the first sheath has a first channel for the shoulder belt portion to pass through.

According to an embodiment, the first sheath includes a first half part and a second half part that are connected with each other, a side portion of the first half part and a side portion of the second half part, which are opposite to each other, are detachably connected to define the first channel; and/or the first sheath is provided with a positioning structure, and the hook is detachably connected to the positioning structure.

According to an embodiment, the positioning structure includes a strip, two ends of the strip are connected to an inner surface of the first sheath, and a middle part of the strip is hooked with the hook.

According to an embodiment, the hook has a connecting portion; the woven tape has a plurality of indication areas corresponding to various height ranges of children, so that the user connects corresponding indication areas to the connecting element according to heights of the children.

According to an embodiment, the plurality of indication areas are color indication areas or light indication areas; and/or the hook is provided with a prompt area for illustrating the height ranges of the children corresponding to the plurality of indication areas.

According to an embodiment, at least one of the first engaging element and the second engaging element is a second sheath, the second sheath has a second channel for the shoulder belt portion to pass through.

According to an embodiment, the second sheath includes a third half part and a fourth half part that are connected to each other, a side portion of the third half part and a side portion of the fourth half part, which are opposite to each other, are detachably connected to define the second channel; and/or the second sheath is detachably connected to the woven tape.

According to an embodiment, at least one of the first engaging element and the second engaging element is connected to the woven tape with an adjustable position; or the woven tape includes an elastic tape.

According to an embodiment, the safety belt protection device includes a third sheath and a first woven tape; wherein the third sheath is connected to a first side or a second side of the seat body through the first woven tape, the third sheath has a third channel for the shoulder belt portion of the safety belt to pass through, and the first woven tape applies a downward traction on the shoulder belt portion through the third sheath.

According to an embodiment, at least one of the first side and the second side of the seat body is provided with a connecting structure, and the first woven tape is selectively detachably connected to a connecting structure on at least one of the first side and the second side of the seat body.

According to an embodiment, the first woven tape is connected to the first side of the seat body, and the third sheath is detachably connected to the first woven tape; the safety belt protection device further includes a second woven tape connected to the second side of the seat body; wherein the third sheath is adapted to be detachably connected to the second woven tape after being separated from the first woven tape, so as to allow the second woven tape to apply a downward traction on the shoulder belt portion through the third sheath.

According to an embodiment, the third sheath includes a fifth half part and a sixth half part that are connected to each other, a side portion of the fifth half part and a side potion of the sixth half part, which are opposite to each other, are detachably connected to define the third channel.

According to an embodiment, the safety belt protection device includes: a guiding portion receiving a part of the safety belt; a connecting portion connecting the guiding portion to the child safety seat; wherein the connecting element is capable of moving transversely with respect to the child safety seat, so that the guiding part is located at a shoulder on either side of a child.

According to an embodiment, the guiding portion includes: a bottom portion; at least one side portion rising from a transverse edge of the bottom portion in a direction away from the child safety seat and curved towards a transverse center of the bottom portion; and a channel formed between the bottom portion and the side portion, wherein the safety belt extends through the safety belt protection device through the channel.

According to an embodiment, the bottom portion extends obliquely downwards vertically from the child safety seat; and the channel is formed over an entire vertical length of the bottom portion.

According to an embodiment, two side portions are provided to be transversely opposed with each other; and a transverse distance between the two side portions is greater than half of a transverse dimension of the bottom portion.

According to an embodiment, the connecting portion includes: a ball portion slidably engaged to a sliding clot of the child safety seat; and an extension connected between the guiding portion and the ball portion.

According to an embodiment, the ball portion and the guiding portion are respectively located on opposite sides of the sliding slot, and the extension passes through the sliding slot; a diameter of the ball portion is greater than a width of the sliding slot, and is capable of being locked at any end of the sliding slot.

According to an embodiment, the ball portion, the extension and the guiding portion are formed as an integral structure.

According to an embodiment, the connecting portion includes: an engagement element slidably engaged to the sliding slot of the child safety seat; and a connecting belt connected between the guiding portion and the engagement element.

According to an embodiment, the engagement element includes: a first transverse portion around which the connecting belt extends; two second transverse portions disposed opposite to each other, and located on vertical sides of the first transverse portion, each of the second transverse portions extending across the entire transverse dimension of the engagement element or being interrupted at a transverse middle; and two vertical portions disposed opposite to each other, each of the vertical portions being connected at a middle thereof to one end of the first transverse portion and at both ends thereof to one end of one of the second transverse portions, respectively.

According to an embodiment, the sliding slot extends transversely, and is provided with at least one protrusion, the protrusion extends vertically from a transverse edge of the sliding slot towards inside of the sliding slot, and a spacing is formed the protrusion and either end of the sliding slot.

According to an embodiment, a pair of protrusions are provided near each of the transverse end of the sliding slot, and each pair of protrusions are respectively disposed on each of two vertical sides of the sliding slot and opposite to each other.

According to an embodiment, a length of the vertical portions is greater than a width of the sliding slot; and the sliding slot extends along the transverse direction and is provided with at least one protrusion, and a distance between one protrusion and the edge of the sliding slot, or a distance between two opposite protrusions, is slightly smaller than a width of the first transverse portion.

According to an embodiment, the guiding portion is made of energy-absorbing material.

According to an embodiment, a child safety seat, wherein the child safety seat includes the anti-slip mechanism according to the present disclosure and/or the safety belt protection device according to the present disclosure.

According to an embodiment, a child safety seat, wherein, the child safety seat includes a seat body and the safety belt protection device according to the present disclosure; wherein a first side of the seat body is provided with a first opening, a second side of the seat body is provided with a second opening, a first end of the woven tape protrudes from the first side through the first opening and be connected to the first engaging element, a second end of the woven tape protrudes from the second side through the second opening and be connected to the second engaging element.

According to an embodiment, a first receiving groove is provided on a back of the first side of the seat body, and the first receiving groove is configured to accommodate the first engaging element. and/or, a second receiving groove is provided on a back of the second side of the seat body, and the second receiving groove is configured to accommodate the second engaging element.

According to an embodiment, a child safety seat, wherein the child safety seat includes: a seat body for carrying a child; a headrest portion connected vertically above the seat body; and the safety belt protection device according to the present disclosure, the safety belt protection device being connected to the seat body or the headrest portion.

According to an embodiment, a position of the headrest portion is adjustable with respect to the seat body.

While preferred embodiments have been shown and described herein, it should be understood that these embodiments are given by way of example only. Numerous variations, changes and substitutions will occur to those skilled in the art without departing from the spirit of the present disclosure. Accordingly, the appended claims are intended to cover all such modifications as fall within the spirit and scope of the present disclosure.

1. A anti-slip mechanism, wherein the anti-slip mechanism is disposed on at least one of a seat cloth and a seat body of a child safety seat to prevent the seat cloth of the child safety seat from sliding with respect to an object that contacts with the seat cloth;
wherein the anti-slip mechanism comprises a first anti-slip portion disposed on at least one of an outer surface of the seat cloth, an inner surface of the seat cloth, and the seat body.

2. (canceled)

3. The anti-slip mechanism according to claim 1, wherein the first anti-slip portion is a single component provided on the seat cloth, or includes a plurality of components evenly distributed on the seat cloth.

4-12. (canceled)

13. The anti-slip mechanism according to claim 1, wherein the anti-slip mechanism comprises:
a second anti-slip portion for positioning the seat cloth on the seat body of the child safety seat covered by the seat cloth;
the second anti-slip portion comprises: one or more connecting elements disposed on the seat cloth; and one or more fitting elements disposed at a corresponding position on the seat body;
the connecting elements and the fitting elements are disposed centrally or symmetrically with respect to a longitudinal central axis of the child safety seat;
one of the connecting element and the fitting element is a clamping opening or a clamping slot or a cloth loop; the other of the connecting element and the fitting element is a hook or a fixing buckle; and
the one or more connecting elements are disposed on a buttock area of the seat cloth, and the one or more fitting elements are disposed on an area of the seat body corresponding to the buttock area.

14-18. (canceled)

19. A safety belt protection device installed to a seat body of a child safety seat, wherein the safety belt protection device is configured to engage at least a part of a safety belt and limit movement of the safety belt with respect to the child safety seat.

20. The safety belt protection device according to claim 19, wherein the safety belt protection device comprises:
a first engaging element;
a second engaging element;
a woven tape, through which the first engaging element and the second engaging element are connected;
wherein the woven tape is adapted to be disposed around the seat body, such that the first engaging element protrudes from a first side of the seat body, and the second engaging element protrudes from a second side of the seat body;
such that via the woven tape is pulled, one of the first engaging element and the second engaging element is retracted with respect to the seat body, and the other of the first engaging element and the second engaging element is pulled out with respect to the seat body, wherein the first engaging element or the second engaging element that is pulled out is configured to be detachably connected with a shoulder belt portion of the safety belt, so as to apply a downward traction on the shoulder belt portion; and
the woven tape is provided with a first limiting structure, and the first limiting structure is located between the first engaging element and the second engaging element and is adapted to cooperate with a second limiting structure on the seat body to limit a pulling stroke of the woven tape.

21. (canceled)

22. The safety belt protection device according to claim 20, wherein
the second limiting structure comprises a first blocking surface and a second blocking surface that are disposed opposite to each other, the first blocking surface is provided with a first perforation, and the second blocking surface is provided with a second perforation;
the first limiting structure includes a limiting block fixed on the woven tape, the woven tape passes through the first perforation and the second perforation, and the limiting block is located between the first blocking surface and the second blocking surface; and
a cross-sectional area of the limiting block in a direction perpendicular to an extending direction of the woven tape is larger than an opening area each of the first perforation and the second perforation.

23. (canceled)

24. The safety belt protection device according to claim 22, wherein
an auxiliary belt is attached to a middle of the woven tape, and two ends of the auxiliary belt are respectively connected to the woven tape; the first limiting structure comprises a limiting ring surrounded by the woven tape and the auxiliary belt; and
the second limiting structure comprises a limiting column, and the limiting column penetrates through the limiting ring.

25. The safety belt protection device according to claim 20, wherein at least one of the first engaging element and the second engaging element comprises a hook for being hooked with the shoulder belt portion.

26. The safety belt protection device according to claim 25, wherein at least one of the first engaging element and the second engaging element further comprises a first sheath, at least a part of the hook is wrapped in the first sheath, and the first sheath has a first channel for the shoulder belt portion to pass through;
the first sheath comprises a first half part and a second half part that are connected with each other, a side portion of the first half part and a side portion of the second half part, which are opposite to each other, are detachably connected to define the first channel;
the first sheath is provided with a positioning structure, and the hook is detachably connected to the positioning structure; and
the positioning structure comprises a strip, two ends of the strip are connected to an inner surface of the first sheath, and a middle part of the strip is hooked with the hook.

27-28. (canceled)

29. The safety belt protection device according to claim 25, wherein:
the hook has a connecting portion;
the woven tape has a plurality of indication areas corresponding to various height ranges of children, so that the user connects corresponding indication areas to the connecting portion according to heights of the children;
the plurality of indication areas are color indication areas or light indication areas; and
the hook is provided with a prompt area for illustrating the height ranges of the children corresponding to the plurality of indication areas.

30. (canceled)

31. The safety belt protection device according to claim 25, wherein at least one of the first engaging element and the second engaging element is a second sheath, the second sheath has a second channel for the shoulder belt portion to pass through;
the second sheath comprises a third half part and a fourth half part that are connected to each other, a side portion of the third half part and a side portion of the fourth half part, which are opposite to each other, are detachably connected to define the second channel; and
the second sheath is detachably connected to the woven tape.

32-33. (canceled)

34. The safety belt protection device according to claim 19, wherein the safety belt protection device comprises a third sheath and a first woven tape; wherein the third sheath is connected to a first side or a second side of the seat body through the first woven tape, the third sheath has a third channel for the shoulder belt portion of the safety belt to pass through, and the first woven tape applies a downward traction on the shoulder belt portion through the third sheath.

35. The safety belt protection device according to claim 34, wherein at least one of the first side and the second side of the seat body is provided with a connecting structure, and the first woven tape is selectively detachably connected to a connecting structure on at least one of the first side and the second side of the seat body;
the first woven tape is connected to the first side of the seat body, and the third sheath is detachably connected to the first woven tape;
the safety belt protection device further comprises a second woven tape connected to the second side of the seat body;
wherein the third sheath is adapted to be detachably connected to the second woven tape after being separated from the first woven tape, so as to allow the second woven tape to apply a downward traction on the shoulder belt portion through the third sheath; and
the third sheath comprises a fifth half part and a sixth half part that are connected to each other, a side portion of the fifth half part and a side potion of the sixth half part, which are opposite to each other, are detachably connected to define the third channel.

36-37. (canceled)

38. The safety belt protection device according to claim 19, wherein the safety belt protection device comprises:
a guiding portion receiving a part of the safety belt;
a connecting portion connecting the guiding portion to the child safety seat;
wherein the connecting portion element is capable of moving transversely with respect to the child safety seat, so that the guiding part is located at a shoulder on either side of a child;
the guiding portion comprises:
a bottom portion;
at least one side portion rising from a transverse edge of the bottom portion in a direction away from the child safety seat and curved towards a transverse center of the bottom portion; and
a channel formed between the bottom portion and the side portion, wherein the safety belt extends through the safety belt protection device through the channel.

39-41. (canceled)

42. The safety belt protection device according to claim 38, wherein
the connecting portion comprises:
a ball portion slidably engaged to a sliding slot of the child safety seat; and
an extension connected between the guiding portion and the ball portion.

43. The safety belt protection device according to claim 42, wherein
the ball portion and the guiding portion are respectively located on opposite sides of the sliding slot, and the extension passes through the sliding slot; and
a diameter of the ball portion is greater than a width of the sliding slot, and is capable of being locked at any end of the sliding slot.

44. (canceled)

45. The safety belt protection device according to claim 38, wherein
the connecting portion comprises:
an engagement element slidably engaged to the sliding slot of the child safety seat; and
a connecting belt connected between the guiding portion and the engagement element;
the engagement element comprises:
a first transverse portion around which the connecting belt extends;
two second transverse portions disposed opposite to each other, and located on vertical sides of the first transverse portion, each of the second transverse portions extending across the entire transverse dimension of the engagement element or being interrupted at a transverse middle; and
two vertical portions disposed opposite to each other, each of the vertical portions being connected at a middle thereof to one end of the first transverse portion and at both ends thereof to one end of one of the second transverse portions, respectively.

46. (canceled)

47. The safety belt protection device according to claim 42, wherein
the sliding slot extends transversely, and is provided with at least one protrusion, the protrusion extends vertically from a transverse edge of the sliding slot towards inside of the sliding slot, and a spacing is formed the protrusion and either end of the sliding slot; and
a pair of protrusions are provided near each of the transverse end of the sliding slot, and each pair of protrusions are respectively disposed on each of two vertical sides of the sliding slot and opposite to each other.

48. (canceled)

49. The safety belt protection device according to claim 45, wherein
a length of the vertical portions is greater than a width of the sliding slot; and
the sliding slot extends along the transverse direction and is provided with at least one protrusion, and a distance between one protrusion and the edge of the sliding slot, or a distance between two opposite protrusions, is slightly smaller than a width of the first transverse portion.

50. (canceled)

51. A child safety seat, wherein the child safety seat comprises the anti-slip mechanism according to claim 1.

52-55. (canceled)
